(19) United States
(12) Patent Application Publication
(10) Pub. No.: US 2015/0117652 A1
(43) Pub. Date: Apr. 30, 2015

(54) SOUND SOURCE DETECTION DEVICE, NOISE MODEL GENERATION DEVICE, NOISE REDUCTION DEVICE, SOUND SOURCE DIRECTION ESTIMATION DEVICE, APPROACHING VEHICLE DETECTION DEVICE AND NOISE REDUCTION METHOD

(71) Applicants: Jun Sato, Susono-shi (JP); Ryuji Funayama, Yokohama-shi (JP); Tomoya Takatani, Nissin-shi (JP); Toshiki Kindo, Yokohama-shi (JP); Hideo Fukamachi, Hadano-shi (JP)

(72) Inventors: Jun Sato, Susono-shi (JP); Ryuji Funayama, Yokohama-shi (JP); Tomoya Takatani, Nissin-shi (JP); Toshiki Kindo, Yokohama-shi (JP); Hideo Fukamachi, Hadano-shi (JP)

(73) Assignee: TOYOTA JIDOSHA KABUSHIKI KAISHA, Toyota-shi, Aichi (JP)

(21) Appl. No.: 14/404,500

(22) PCT Filed: May 31, 2012
(86) PCT No.: PCT/JP2012/064196

§ 371 Date: Dec. 22, 2014

(51) Int. Cl. H04R 29/00; G10K 11/00

(52) U.S. Cl. CPC H04R 29/00; G10K 11/002
USPC 381/56

(57) ABSTRACT

Disclosed is a noise model generation device that generates a noise model suitable for each environment by determining whether an sound source of a detection target is included in sound information collected by an sound collector with high accuracy. The noise model generation device generates a noise model relating to noise information other than the sound source of the detection target included in the sound information collected by the sound collector, which acquires a power spectrum from the sound information; determines whether the sound source of the detection target is included in the sound information collected by evaluating a probability density distribution (histogram) of the power spectrum; and generates a noise model from the collected sound information when it is determined that the sound source of the detection target is not included in the collected sound information.

### TECHNICAL FIELD

The present invention relates to an sound source detection device that detects an sound source of a detection target from sound information collected by an sound collector, to a noise model generation device that generates a noise model relating to noise information other than the sound source of the detection target included in the sound information collected by the sound collector, and to a noise reduction device, an sound source direction estimation device, an approaching vehicle detection device, and a noise reduction method that use the noise model.

### BACKGROUND ART

An sound source direction estimation device (for example, approaching vehicle detection device) that collects peripheral sound by plural sound collectors and estimates the direction or the like of the sound source (for example, traveling sound of an approaching vehicle) based on an sound arrival time difference between the respective sound collectors or the like has been developed. Patent Literature 1 discloses a device that removes frequency components of a low frequency band and a high frequency band from an electric signal output by plural microphones (sound collectors) disposed at predetermined intervals using a band pass filter, respectively, to convert the signal into a corrected electric signal, calculates power in a predetermined frequency band in which a characteristic traveling sound of a vehicle from the corrected electric signal appears, and determines, when the power level is larger than a predetermined value, that an approaching vehicle is present, and removes an unnecessary noise component from the corrected electric signal to convert the signal into a noise reduced signal, calculates cross-correlation between the noise reduced signals of the plural microphones, and calculates the approaching direction of the approaching vehicle from the arrival time difference where the correlation is the maximum.

### CITATION LIST

### Patent Literature

[Patent Literature 1] Japanese Unexamined Utility Model Registration Application Publication No. 5-92767
[Patent Literature 2] Japanese Unexamined Patent Application Publication No. 2008-76975
[Patent Literature 3] Japanese Unexamined Patent Application Publication No. 2011-186384

### SUMMARY OF INVENTION

### Technical Problem

In order to estimate an sound source with high accuracy, it is necessary to reduce noise other than an sound source of a detection target from sound information collected by an sound collector (noise reduction), and to perform estimation using the sound information in which the noise is reduced. In the related art, there is a noise reduction technique that employs a noise model that is prepared in advance or a noise model that is forcibly generated at a predetermined timing. However, when an sound source direction estimation device is applied to a device that is used outdoors such as an approaching vehicle detection device, since a peripheral environment that is an sound collection target of the sound collector is changed, a noise source is also changed. Thus, if the noise model that is prepared in advance or the noise model that is generated at the predetermined timing is used under such various environments, it may be difficult to obtain a noise model suitable for each environment. Thus, the noise component may not be sufficiently reduced, or even a necessary sound source may be reduced. As a result, the estimation accuracy of the sound source is reduced.

Accordingly, an object of the invention is to provide an sound source detection device that detects an sound source of a detection target with high accuracy by determining whether the sound source of the detection target is included in sound information collected by an sound collector with high accuracy, a noise model generation device that generates a noise model suitable for each environment, and a noise reduction device, an sound source direction estimation device, an approaching vehicle detection device, and a noise reduction method that use the noise model suitable for each environment.

### Solution to Problem

According to an aspect of the invention, there is provided an sound source detection device that detects an sound source of a detection target from sound information collected by an sound collector, including: a power spectrum acquisition unit that acquires a power spectrum from the sound information collected by the sound collector, and a determination unit that determines whether the sound source of the detection target is included in the sound information collected by the sound collector, by evaluating a probability density distribution of the power spectrum acquired by the power spectrum acquisition unit.

In the sound source detection device, the sound collector is provided, and peripheral sound is collected by the sound collector to acquire the sound information. Further, in the sound source detection device, the power spectrum (power (energy) for each sound frequency) is acquired from the sound information by the power spectrum acquisition unit. In addition, in the sound source detection device, it is determined by the determination unit whether the sound source of the detection target is included in the sound information by evaluating the probability density distribution of the power spectrum to detect the sound source from the sound information. Between under an environment where the sound source of the detection target is not present (when only a noise component is included in the sound information) and under an environment where the sound source of the detection target is present (when an sound source component of the detection target, in addition to the noise component, is included in the sound information), the shape of the probability density distribution of the power spectrum is apparently different. Accordingly, it is possible to determine whether only the noise component (for example, white noise or pink noise) is included in the sound information or the sound source component of the detection target in addition to the noise component is also included in the sound information from the probability density distribution of the power spectrum acquired from the sound information, with high accuracy. In this way, the sound source detection device can determine whether the sound source of the detection target is included in the sound information with high accuracy by evaluating the probability density distribution of the power spectrum of the sound information collected by the sound collector, and can detect the sound source of the detection target with high accuracy.

When evaluating the probability density distribution of the power spectrum, a method for calculating the probability density distribution and performing the evaluation using the probability density distribution may be used, or a method for performing the evaluation using the power spectrum without calculating the probability density distribution may be used.

In the sound source detection device according to this aspect of the invention, it is preferable that the determination unit determine whether the sound source of the detection target is included in the sound information collected by the sound collector, by evaluating a probability density distribution of a power spectrum in a first frequency band set based on the sound source of the detection target and a probability density distribution of a power spectrum in a second frequency band other than the first frequency band.

Under the environment where the sound source of the detection target is not present (under a noise environment due to white noise or pink noise, for example), there is continuity in the power distribution in all the frequency bands. On the other hand, under the environment where the sound source of the detection target is present, since the power distribution is changed in the frequency band where the sound source is included, the continuity disappears between the frequency band where the sound source is included and other frequency bands. Accordingly, by comparing the probability density distributions of the power spectra in two frequency bands, it is possible to determine whether the environment is the environment where the sound source of the detection target is not present or the environment where the sound source of the detection target is present with high accuracy. Thus, by comparing and evaluating the probability density distribution of the power spectrum in the first frequency band where the sound source of the detection target is included with the probability density distribution of the power spectrum in the second frequency band other than the first frequency band, the sound source detection device determines whether the sound source of the detection target is included in the sound information by the determination unit, to detect the sound source from the sound information. In this way, in the sound source detection device, by evaluating the probability density distribution of the power spectrum in the first frequency band where the sound source of the detection target is included with the probability density distribution of the power spectrum in the second frequency band other than the first frequency band, it is possible to determine whether the sound source of the detection target is included in the sound information with high accuracy, and to detect the sound source of the detection target with high accuracy.

The sound source detection device according to this aspect of the invention may further include a scale parameter calculation unit that calculates a scale parameter of gamma distribution by gamma distribution fitting based on the power spectrum, and the determination unit may evaluate the probability density distribution of the power spectrum using the scale parameter calculated by the scale parameter calculation unit. With such a configuration, in the sound source detection device, by using the scale parameter based on the gamma distribution fitting, it is possible to evaluate the probability density distribution of the power spectrum with high accuracy.

According to another aspect of the invention, there is provided a noise model generation device that generates a noise model relating to noise information other than an sound source of a detection target included in sound information collected by an sound collector, including: a power spectrum acquisition unit that acquires a power spectrum from the sound information collected by the sound collector; a determination unit that determines whether the sound source of the detection target is included in the sound information collected by the sound collector, by evaluating a probability density distribution of the power spectrum acquired by the power spectrum acquisition unit; and a noise model generation unit that generates a noise model from the sound information collected by the sound collector when it is determined by the determination unit that the sound source of the detection target is not included in the sound information.

In the noise model generation device, the sound collector is provided, and peripheral sound is collected by the sound collector to acquire the sound information. Further, in the noise model generation device, the power spectrum is acquired from the sound information by the power spectrum acquisition unit. In addition, in the noise model generation device, it is determined by the determination unit whether the sound source of the detection target is included in the sound information by evaluating the probability density distribution of the power spectrum to determine a timing suitable for noise model generation. As described above, since the shape of the probability density distribution of the power spectrum is apparently different between under the environment where the sound source of the target detection is not present and under the environment where the sound source of the target detection is present, it is possible to determine whether the environment is the environment where the sound source of the detection target is not present or the environment where the sound source of the detection target is present from the shape of the probability density distribution of the power spectrum acquired from the sound information with high accuracy. Furthermore, in order to detect the sound source of the detection target using the sound information from which the noise is reduced based on the noise model with high accuracy, it is necessary to generate the noise model from the sound information collected under the environment where the sound source of the detection target is not present. In this regard, when the noise model is generated from the sound information collected under the environment where the sound source of the detection target is present, if the noise model is used, even a necessary sound component is reduced from the sound information. If the timing suitable for the noise model generation (environment where the sound information of the detection target is not present) is determined, the noise model generation device generates the noise model from the sound information collected at the timing by the noise model generation unit. In this way, in the noise model generation device, since it is possible to determine whether the sound source of the detection target is included in the sound information with high accuracy by evaluating the probability density distribution of the power spectrum of the sound information collected by the sound collector, it is possible to determine a timing suitable for the noise model generation, and to generate a noise model suitable for each environment.

In the noise model generation device according to this aspect of the invention, it is preferable that the determination unit determine whether the sound source of the detection target is included in the sound information collected by the sound collector by evaluating the probability density distribution of the power spectrum in the first frequency band set based on the sound source of the detection target and the probability density distribution of the power spectrum in the second frequency band other than the first frequency band.

As described above, under the environment where the sound source of the detection target is not present, there is continuity in the power distribution in all the frequency bands, but under the environment where the sound source of the detection target is present, the continuity disappears between the frequency band where the sound source of the detection target is included and other frequency bands. Accordingly, by comparing the probability density distributions of the power spectra in two frequency bands, it is possible to determine whether the environment is the environment where the sound source of the detection target is not present (environment suitable for the noise model generation) or the environment where the sound source of the detection target is present (environment unsuitable for the noise model generation) with high accuracy. Thus, in the noise model generation device, by comparing and evaluating the probability density distribution of the power spectrum in the first frequency band where the sound source of the detection target is included with the probability density distribution of the power spectrum in the second frequency band other than the first frequency band, by the determination unit, it is determined whether the sound source of the detection target is included in the sound information. Further, in the noise model generation device, if it is determined by the determination unit that the sound source of the detection target is not included (if it is determined that the timing is suitable for the noise model generation), the noise model is generated from the sound information collected at the timing by the noise model generation unit. In this way, in the noise model generation device, by evaluating the probability density distribution of the power spectrum in the first frequency band where the sound source of the detection target is included with the probability density distribution of the power spectrum in the second frequency band other than the first frequency band, it is possible to determine whether the sound source of the detection target is included in the sound information with high accuracy, and to determine the timing suitable for the noise model generation.

The noise model generation device according to this aspect of the invention may further include a scale parameter calculation unit that calculates a scale parameter of gamma distribution by gamma distribution fitting based on the power spectrum, and the determination unit may evaluate the probability density distribution of the power spectrum using the scale parameter calculated by the scale parameter calculation unit. With such a configuration, in the noise model generation device, by using the scale parameter based on the gamma distribution fitting, it is possible to evaluate the probability density distribution of the power spectrum with high accuracy.

The noise model generation device according to this aspect of the invention may further include a point sound source detection unit that detects a point sound source from the sound information collected by the sound collector, and even if it is determined by the determination unit that the sound source of the detection target is not included in the sound information, when the point sound source is detected by the point sound source detection unit, the noise model generation unit may not generate the noise model.

In the noise model generation device, the point sound source is detected from the sound information collected by the sound collector by the point sound source detection unit. The point sound source refers to a specific sound source that is not an environmental noise such as white noise or pink noise, which may be the sound source of the detection target. Thus, even if it is determined by the determination unit that the sound source of the detection target is not included in the sound information (even if it is determined that the noise model generation is possible), when the point sound source is detected by the point sound source detection unit (when there is a possibility that the sound source of the detection target is present), the noise model generation unit of the noise model generation device does not generate the noise model. In this way, in the noise model generation device, even if it is determined that the noise model generation is possible by the evaluation of the probability density distribution of the power spectrum, by determining whether to generate the noise model in consideration of the presence or absence of the point sound source, it is possible to determine a timing suitable for the noise model generation with high accuracy.

The noise model generation device according to this aspect of the invention may further include a characteristic sound detection unit that detects a characteristic sound other than the sound source of the detection target from the sound information collected by the sound collector, and when the characteristic sound other than the sound source of the detection target is detected by the characteristic sound detection unit, the noise model generation unit may generate the noise model.

In the noise model generation device, the characteristic sound other than the sound source of the detection target is detected from the sound information collected by the sound collector by the characteristic sound detection unit. The characteristic sound refers to an sound source other than the sound source of the detection target in the specific sound source (point sound source) that is not the environment noise such as white noise or pink noise, for example. Thus, when the characteristic sound is detected in the characteristic sound detection unit, the noise model generation unit of the noise model generation device generates the noise model. In this way, in the noise model generation device, by determining whether to generate the noise model in consideration of the presence or absence of the characteristic sound other than the sound source of the detection target, it is possible to determine a timing suitable for the noise model generation with high accuracy.

The noise model generation device according to this aspect of the invention may further include, when the noise model is already generated by the noise model generation unit, a noise model update unit that updates the noise model using the sound information collected by the sound collector. With such a configuration, in the noise model generation device, when the noise model is already generated, by updating the noise model in consideration of the sound information collected under the current environment, it is possible to generate a suitable noise model in accordance with an environmental change with a small processing load.

According to still another aspect of the invention, there is provided a noise reduction device that reduces noise other than an sound source of a detection target included in sound information collected by an sound collector, including any one of the above-described noise model generation devices, wherein the noise other than the sound source of the detection target is reduced from the sound information collected by the sound collector using the noise model generated by the noise model generation device. According to the noise reduction device, by using the noise model suitable for each environment generated by each noise model generation device, it is possible to reduce the noise other than the sound source of the detection target from the sound information collected by the sound collector with high accuracy.

According to still another aspect of the invention, there is provided an sound source direction estimation device that estimates the direction of an sound source of a detection target included in sound information collected by an sound collector, including the above-described noise reduction device, wherein the direction of the sound source of the detection target is estimated from the sound information from which the noise is reduced by the noise reduction device. According to the sound source direction estimation device, by using the sound information in which the noise is reduced by the noise reduction device with high accuracy, it is possible to estimate the direction of the sound source of the detection target included in the sound information collected by the sound collector with high accuracy.

According to still another aspect of the invention, there is provided an approaching vehicle detection device that detects an approaching vehicle based on sound information collected by an sound collector mounted on a vehicle, including the above-described sound source direction estimation device, wherein the sound source direction estimation device estimates the direction of an sound source generated from the approaching vehicle. According to the approaching vehicle detection device, by estimating the direction or the like of the sound source (for example, traveling sound) generated from the approaching vehicle by the sound source direction estimation device, it is possible to detect the direction or the like of the approaching vehicle with high accuracy.

Further, according to still another aspect of the invention, there is provided a noise reduction device that reduces noise other than an sound source of a detection target included in sound information collected by an sound collector, including: a determination unit that determines whether the sound source of the detection target is included in the sound information collected by the sound collector, a noise model generation unit that generates a noise model from the sound information collected by the sound collector if it is determined by the determination unit that the sound source of the detection target is not included in the sound information; and a noise reduction unit that reduces the noise other than the sound source of the detection target from the sound information collected by the sound collector using the noise model generated by the noise model generation unit.

In the noise reduction device, the sound collector is provided, and peripheral sound is collected by the sound collector to obtain the sound information. Further, in the noise reduction device, it is determined by the determination unit whether the sound source of the detection target is included in the sound information to determine a timing suitable for the noise model generation. In order to detect the sound source of the detection target using the sound information in which the noise is reduced based on the noise model with high accuracy, it is necessary to generate the noise model from the sound information collected under the environment where the sound source of the detection target is not present. In this regard, when the noise model is generated from the sound information collected under the environment where the sound source of the detection target is present, if the noise model is used, even a necessary sound component is reduced from the sound information. If the timing suitable for the noise model generation (environment where the sound information of the detection target is not present) is determined, the noise reduction device generates the noise model from the sound information collected at the timing by the noise model generation unit. Further, in the noise reduction device, the noise other than the sound source of the detection target is reduced from the sound information collected by the sound collector using the generated noise model by the noise reduction unit. In this way, by generating the noise model at the timing suitable for generation of the noise model in which the sound source of the detection target is not included in the sound information collected by the sound collector, and by using the noise model suitable for each environment, the noise reduction device can reduce the noise other than the sound source of the detection target from the sound information collected by the sound collector with high accuracy.

In the noise model generation device according to this aspect of the invention, the noise reduction unit may reduce the noise other than the sound source of the detection target from the sound information collected by the sound collector using the noise model generated by the noise model generation unit if the noise model generated by the noise model generation unit is present, and may reduce the noise other than the sound source of the detection target from the sound information collected by the sound collector using a noise model that is prepared in advance or may not reduce the noise if the noise model generated by the noise model generation unit is not present.

The noise model generation unit generates the noise model at a timing suitable for the noise model generation, but there is a case where the noise model is not yet generated. Thus, in the noise reduction device, when the noise model is generated by the noise model generation unit, the noise reduction unit reduces the noise other than the sound source of the detection target from the sound information collected by the sound collector using the generated noise model. Further, in the noise reduction device, when the noise model is not yet generated by the noise model generation unit, the noise reduction unit reduces the noise other than the sound source of the detection target from the sound information collected by the sound collector using the noise model that is prepared in advance, or does not reduce the noise.

According to still another aspect of the invention, there is provided a noise reduction method for reducing noise other than an sound source of a detection target included in sound information collected by an sound collector, including: a determination step of determining whether the sound source of the detection target is included in the sound information collected by the sound collector, a noise model generation step of generating a noise model from the sound information collected by the sound collector if it is determined that the sound source of the detection target is not included in the sound information in the determination step; and a noise reduction step of reducing the noise other than the sound source of the detection target from the sound information collected by the sound collector using the noise model generated in the noise model generation step. According to the noise reduction method, the same operation as in the above-described noise reduction device is performed, and thus, the same effects are achieved.

### Advantageous Effects of Invention

According to the invention, by evaluating the probability density distribution of the power spectrum of the sound information collected by the sound collector, it is possible to determine whether the sound source of the detection target is included in the sound information with high accuracy, and to thus obtain the sound source of the detection target with high accuracy. Further, according to the invention, since it is possible to determine whether the sound source of the detection target is included in the sound information with high accuracy by evaluating the probability density distribution of the power spectrum of the sound information collected by the sound collector, it is possible to determine a timing suitable for generation of the noise model, and to generate a noise model suitable for each environment. Furthermore, according to the invention, by generating the noise model at the timing suitable for generation of the noise model in which the sound source of the detection target is not included in the sound information collected by the sound collector, and by using the noise model suitable for each environment, it is possible to reduce the noise other than the sound source of the detection target from the sound information collected by the sound collector with high accuracy.

### BRIEF DESCRIPTION OF DRAWINGS

FIG. 1 is a configuration diagram of an approaching vehicle detection device according to the first embodiment.

FIG. 2 shows an example of data of time zones where traveling sound is observed, in which (a) shows a power spectrum, and (b) shows a histogram of the power spectrum.

FIG. 3 shows an example of data of time zones where traveling sound is not observed, in which (a) shows a power spectrum, and (b) shows a histogram of the power spectrum.

FIG. 4 shows an example of a temporal change of a scale parameter.

FIG. 5 is a flowchart illustrating the flow of an overall operation in the approaching vehicle detection device according to the embodiment of the invention.

FIG. 6 is a flowchart illustrating the flow of an operation relating to noise model generation according to the first embodiment.

FIG. 7 is a configuration diagram of an approaching vehicle detection device according to the second embodiment.

FIG. 8 is a diagram illustrating an example of a temporal change of a scale parameter in a frequency band where traveling sound is observed and a scale parameter in a frequency band where traveling sound is not observed.

FIG. 9 is a flowchart illustrating the flow of an operation relating to noise model generation according to the second embodiment.

FIG. 10 is a configuration diagram of an approaching vehicle detection device according to the third embodiment.

FIG. 11 is a flowchart illustrating the flow of an operation relating to noise model generation according to the third embodiment.

FIG. 12 is a configuration diagram of an approaching vehicle detection device according to the fourth embodiment.

FIG. 13 is a flowchart illustrating the flow of an operation relating to noise model generation according to the fourth embodiment.

FIG. 14 is a configuration diagram of an approaching vehicle detection device according to the fifth embodiment.

FIG. 15 is a flowchart illustrating the flow of an operation relating to noise model generation according to the fifth embodiment.

### DESCRIPTION OF EMBODIMENTS

Hereinafter, embodiments of the invention will be described with reference to the accompanying drawings. The same reference numerals are given to the same or equivalent components in the respective drawings, and repetitive description will not be made.

In the embodiments, the invention is applied to an approaching vehicle detection device (sound source direction estimation device) mounted on a vehicle. The approaching vehicle detection device according to the embodiments detects a vehicle that approaches a host vehicle (that is, estimates a direction or the like of traveling sound of another vehicle (sound source of a detection target) present in the vicinity of the host vehicle) based on each sound signal collected by plural microphones (sound collectors), and provides information on the approaching vehicle to a drive assist device. Particularly, in the embodiments, in order to detect the approaching vehicle with high accuracy, a noise model suitable for an environment is generated, and an sound signal in which noise is reduced from the sound signal collected by the sound collector using the noise model is used. The embodiments include five embodiments having different configurations for the noise model generation, in which the first embodiment is a basic embodiment, and in the respective embodiments, functions are sequentially added.

The traveling sound of the vehicle mainly includes a road noise (frictional sound between a tire surface and a road surface), and a pattern noise (air vortices (compression and release) in tire grooves). Frequency bands of the traveling sound of the vehicle are measured in advance through an actual vehicle test or the like.

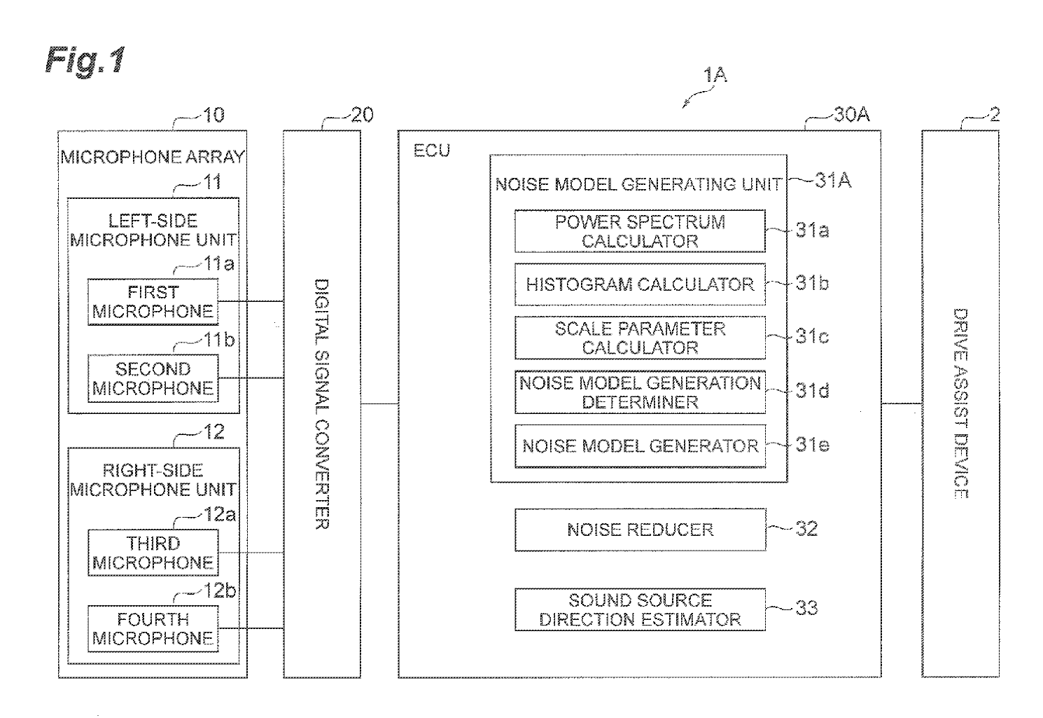

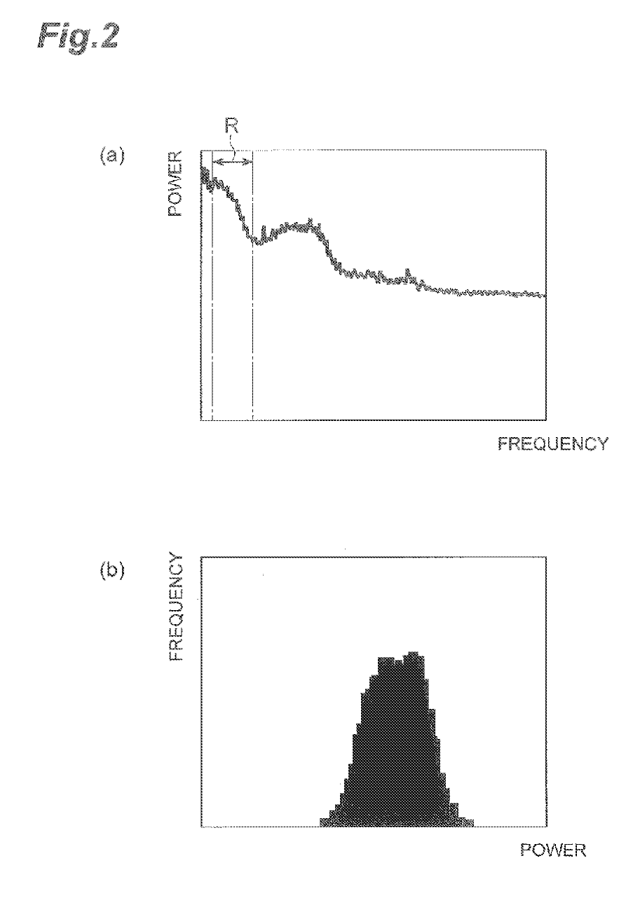

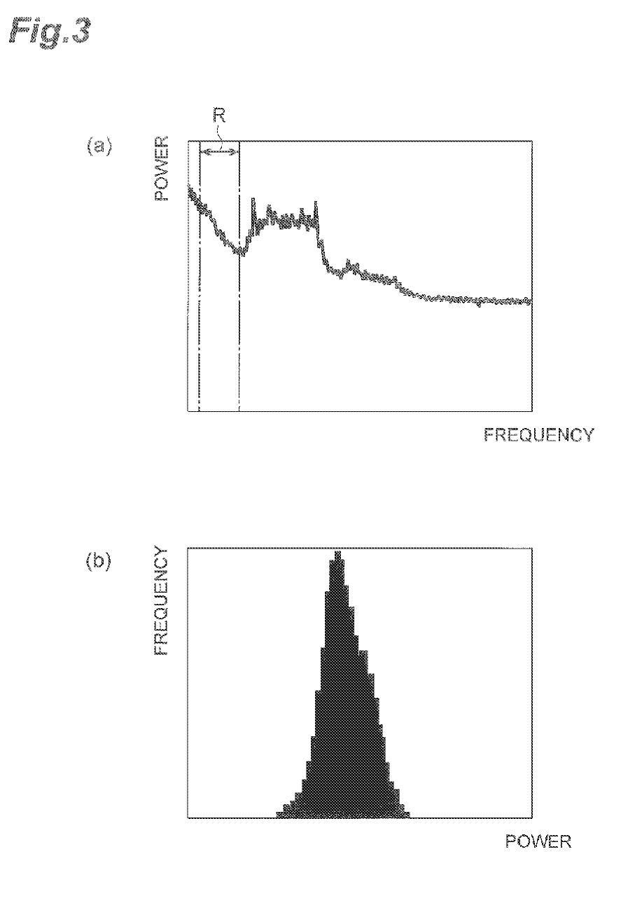

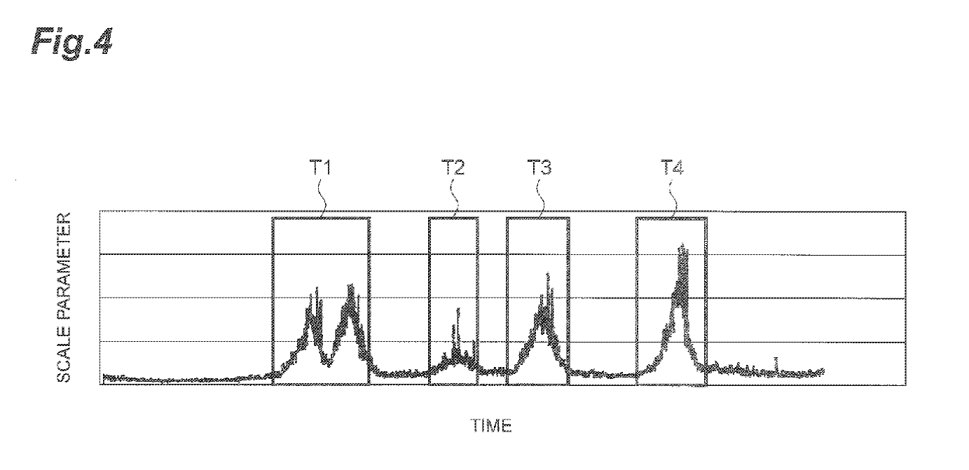

An approaching vehicle detection device 1A according to the first embodiment will be described with reference to FIGS. 1 to 4. FIG. 1 is a configuration diagram of the approaching vehicle detection device according to the first embodiment. FIG. 2 shows an example of data of time zones where the traveling sound is observed, in which (a) shows a power spectrum, and (b) shows a histogram of the power spectrum. FIG. 3 shows an example of data of time zones where the traveling sound is not observed, in which (a) shows a power spectrum, and (b) shows a histogram of the power spectrum. FIG. 4 shows an example of a temporal change of a scale parameter.

In order to determine a timing suitable for the noise model generation, the approaching vehicle detection device 1A determines whether the sound source of the detection target (traveling sound of the vehicle) is included in the sound signal collected by the microphone to determine a timing (section) when the noise model can be generated. For this purpose, the approaching vehicle detection device 1A calculates a power spectrum of the sound signal, and evaluates a histogram (probability density distribution) of the power spectrum by gamma distribution fitting.

Before specifically describing the configuration of the approaching vehicle detection device 1A, the power spectra and the histograms of the power spectra when the traveling sound is included in the sound signal and when the traveling sound is not included in the sound signal will be described with reference to (a) and (b) of FIG. 2, and (a) and (b) of FIG. 3. (a) of FIG. 2 shows the power spectrum (power (energy) with respect to each frequency) of the sound signal when the traveling sound is included in the sound signal, and (a) of FIG. 3 shows the power spectrum of the sound signal when the traveling sound is not included in the sound signal. In (a) of FIG. 2 and (a) of FIG. 3, a section indicated by reference symbol R is a frequency band where an sound component of the traveling sound predominantly appears. Further, (b) of FIG. 2 shows the histogram (frequency of each power) of the power spectrum in the frequency band R when the traveling sound is included in the sound signal, and (b) of FIG. 3 shows the histogram of the power spectrum in the frequency band R when the traveling sound is not included in the sound signal.

When comparing power distribution in the frequency band R shown in (a) of FIG. 2 with power distribution in the frequency band R shown in (a) of FIG. 3, it can be understood that the power distributions are different from each other between when only the noise component (for example, environmental noise such as white noise or pink noise) is included in the sound signal and when the traveling sound component of the vehicle in addition to the noise component is included in the sound information. The difference may be easily understood, by comparing the histogram of the power spectrum in the frequency band R shown in (b) of FIG. 2 with the histogram of the power spectrum in the frequency band R shown in (b) of FIG. 3, from the difference in shape of the histograms. In this way, it can be understood whether only the noise component is included in the sound signal or the traveling sound component of the detection target in addition to the noise component is included in the sound signal from the change of the shape of the histograms of the power spectra, in the frequency bands R, of the traveling sound of the detection target.

In addition, in order to detect the traveling sound with high accuracy using the sound signal in which the noise component is reduced based on the noise model, it is necessary to generate the noise model from the sound signal collected under an environment where the traveling sound is not present. In contrast, if the noise model is generated from the sound signal collected under an environment where the traveling sound is present, since the traveling sound component is also included in the noise model, using the noise model may also cause the reduction of a necessary sound component from the sound signal.

Thus, by evaluating the shape of the histograms of the power spectra, it is determined whether the environment is the environment where the traveling sound is not present or the environment where the traveling sound is present, to detect a timing (section) corresponding to the environment where the traveling sound is not present. By generating the noise model using the sound signal collected at this timing, the noise model can be generated from the sound signal in which only the noise component is included.

In order to evaluate the shapes of the histograms, if data (data that includes the traveling sound and data that does not include the traveling sound) on sound signals collected under various environments where the vehicle is traveling is applied to various methods, a result that it is most effective to use a scale parameter based on gamma distribution fitting as a feature amount can be obtained. FIG. 4 shows an example of a temporal change of a scale parameter calculated from a power spectrum of an sound signal collected while the vehicle is traveling as indicated by solid line. As understood from the change of solid line, in a time zone where the traveling sound is not observed, the scale parameter is close to 0, but in time zones T1, T2, T3, and T4 where the traveling sound is observed, the scale parameter becomes noticeably large. In this way, it is possible to determine whether the environment is the environment where the traveling sound is present or the environment where the traveling sound is not present.

Thus, in the first embodiment, in order to evaluate the histograms of the power spectra, a shape parameter of gamma distribution is calculated using the gamma distribution fitting, the scale parameter is calculated from the shape parameter, and the scale parameter is used as a feature amount of evaluation. The gamma distribution is a type of continuous probability distribution, and its property is characterized by two parameters of shape distribution and scale distribution. When the gamma distribution fitting is used, since the shape parameter or the scale parameter can be directly calculated from the power spectrum, the histogram of the power spectrum may be calculated to perform the gamma distribution fitting, or the gamma distribution fitting may be performed without calculation of the histogram.

Here, the configuration of the approaching vehicle detection device 1A will be described. The approaching vehicle detection device 1A includes a microphone array 10, a digital signal converter 20, and an electronic control unit (ECU) 30A (noise model generator 31A, noise reducer 32, and sound source direction estimator 33).

The microphone array 10 includes a left-side microphone unit 11 and a right-side microphone unit 12. The left-side microphone unit 11 and the right-side microphone unit 12 are disposed on the left side and the right side in a width direction (in a left and right direction) at the same height position in a front end portion of the vehicle. The left-side microphone unit 11 includes a first microphone 11a and a second microphone 11b. For example, the first microphone 11a is disposed at the outside on the left side in the width direction, and the second microphone 11b is disposed on a central side of the vehicle with a predetermined interval from the first microphone 11a. The right-side microphone unit 12 includes a third microphone 12a and a fourth microphone 12b. For example, the fourth microphone 12b is disposed at the outside on the right side in the width direction, and the third microphone 12a is disposed on the central side of the vehicle with a predetermined interval from the fourth microphone 12b. The respective microphones 11a, 11b, 12a, and 12b are acoustic electric transducers, each of which converts peripheral sound at the outside of the vehicle into an analog electric signal, and outputs the electric signal (sound signal) to the digital signal converter 20. In the present embodiment, the microphones 11a, 11b, 12a, and 12b correspond to an sound collector disclosed in claims.

If the analog sound signal (electric signal) is input from each of the microphones 11a, 11b, 12a, and 12b, the digital signal converter 20 converts each sound signal into a digital sound signal (electric signal). Further, the digital signal converter 20 outputs the digital sound signal (electric signal) for each microphone to the ECU 30A.

The ECU 30A is an electronic control unit including a central processing unit (CPU), a read only memory (ROM), a random access memory (RAM) and the like, and generally controls the approaching vehicle detection device 1A. The ECU 30A includes the noise model generator 31A (power spectrum calculator 31a, histogram calculator 31b, scale parameter calculator 31c, noise model generation possibility determiner 31d, and noise model generator 31e), the noise reducer 32, and the sound source direction estimator 33. The ECU 30A receives the sound signal (digital electric signal) for each microphone from the digital signal converter 20.

In the first embodiment, the power spectrum calculator 31a corresponds to a power spectrum acquisition unit disclosed in claims, the scale parameter calculator 31c corresponds to a scale parameter calculation unit disclosed in claims, the noise model generation possibility determiner 31d corresponds to a determination unit disclosed in claims, the noise model generator 31e corresponds to a noise model generation unit disclosed in claims, and the noise reducer 32 corresponds to a noise reduction unit disclosed in claims.

The power spectrum calculator 31a performs fast Fourier transform (FFT) for the sound signal using the digital sound signal from the digital signal converter 20, and calculates a power spectrum of the sound signal (power (energy) for each frequency). Here, any one of microphones sound signal among four sound signals of the microphones 11a, 11b, 12a, and 12b may be used, or an sound signal obtained by averaging sound signals of plural microphones (for example, two corresponding microphones on the left-side and the right-side, or all four microphones) among the four sound signals of the microphones 11a, 11b, 12a, and 12b may be used.

The histogram calculator 31b calculates a histogram of a power spectrum in a frequency band where the traveling sound is predominantly included, from the power spectrum calculated in the power spectrum calculator 31a.

The scale parameter calculator 31c performs gamma distribution fitting using data on the power spectrum in the frequency band where the traveling sound is predominantly included to calculate a scale parameter. Specifically, an estimation value of a shape parameter α is calculated by Expression (1). γ in Expression (1) may be calculated by Expression (2) using data array {x: x1, x2, . . . , xN} of power of each frequency in the frequency band where the traveling sound is predominant. Further, an estimation value of a scale parameter θ is calculated using the estimation value of the shape parameter α and the data array {x: x1, x2, . . . , xN} by Expression (3).

$$\begin{matrix}[ Expression 1 ] & \\ \hat{α} = \frac{3 - γ + \sqrt{{( γ - 3 )}^{2} + 24 γ}}{12 γ} & ( 1 ) \\ γ = log ( E [ x ] ) - E ( log x ) & ( 2 ) \\ \hat{θ} = \frac{E [ x ]}{\hat{α}} & ( 3 )\end{matrix}$$

The noise model generation possibility determiner 31d compares the scale parameter calculated in the scale parameter calculator 31c with a threshold value. If the scale parameter is equal to or greater than the threshold value (when it can be determined that the scale parameter is large and the traveling sound is included in the sound signal), the noise model generation possibility determiner 31d determines that the noise model generation is not possible, and if the scale parameter is lower than the threshold value (when it can be determined that the scale parameter is small and the traveling sound is not included in the sound signal), the noise model generation possibility determiner 31d determines that the noise model generation is possible. The threshold value refers to a threshold value for determining whether the traveling sound is included in the sound signal based on the magnitude of the scale parameter, which is set in advance by an experiment or the like.

If the noise model generation possibility determiner 31d determines that the noise model generation is possible, the noise model generator 31e generates the noise model using the digital sound signal from the digital signal converter 20. As such a generation method, a related art method may be used. For example, an sound signal of one any one of microphones among the sound signals of four microphones 11a, 11b, 12a, and 12b may be used as the noise model as it is, or an sound signal obtained by averaging the sound signals of plural microphones among four microphones 11a, 11b, 12a, and 12b may be used as the noise model.

The noise reducer 32 reduces a noise component from the digital sound signal from the digital signal converter 20 for each microphone using the noise model. As the reduction method, a related art method may be used. For example, a section having a value larger than the noise model in the sound signal may be extracted, and only the sound signal in the section may be used by the sound source direction estimator 33. Here, when the noise model generator 31e generates the noise model in advance, this noise model is used, and when the noise model generator 31e does not generate the noise model, a noise model that is prepared in advance is used. The prepared noise model is generated in advance by an experiment or the like.

The sound source direction estimator 33 determines whether the sound source of the detection target (traveling sound (and also the approaching vehicle to the host vehicle)) is present using the sound signal each of the microphones 11a, 11b, 12a, and 12b in which the noise component is reduced by the noise reducer 32, and estimates the direction, distance or the like of the sound source if the sound source is present. As the estimation method, a related art method may be used. For example, a cross power spectrum phase analysis (CSP) method may be used. The CSP method refers to a method for performing matching in the frequency band for the respective sound signals collected using the left and right microphones, calculating a cross-correlation value (CSP coefficient), determining that the sound source is present if the cross-correlation value is equal to or greater than a threshold value, and calculating the direction, distance or the like of the vehicle from an arrival time difference in which the cross-correlation value becomes the maximum when the sound source is present.

The ECU 30A generates approaching vehicle information based on the detection result of the sound source of the detection target of the sound source direction estimator 33, and outputs the approaching vehicle information to the drive assist device 2. The approaching vehicle information includes information on the presence or absence of the approaching vehicle, and information on the direction and distance of the approaching vehicle when the approaching vehicle is present, for example.

The drive assist device 2 is a device that performs various drive assists for a driver. Particularly, if the approaching vehicle information is input from the approaching vehicle detection device 1A every predetermined time, the drive assist device 2 executes a drive assist relating to the approaching vehicle. For example, if the approaching vehicle to the host vehicle is present, the drive assist device 2 determines a possibility of collision of the approaching vehicle with the host vehicle. If it is determined that there is the possibility of a collision, the drive assist device 2 outputs an alarm to the driver, provides the information on the approaching vehicle to the driver, and if the possibility of the collision increases, the drive assist device 2 performs a vehicle control such as automatic braking or automatic steering, for example.

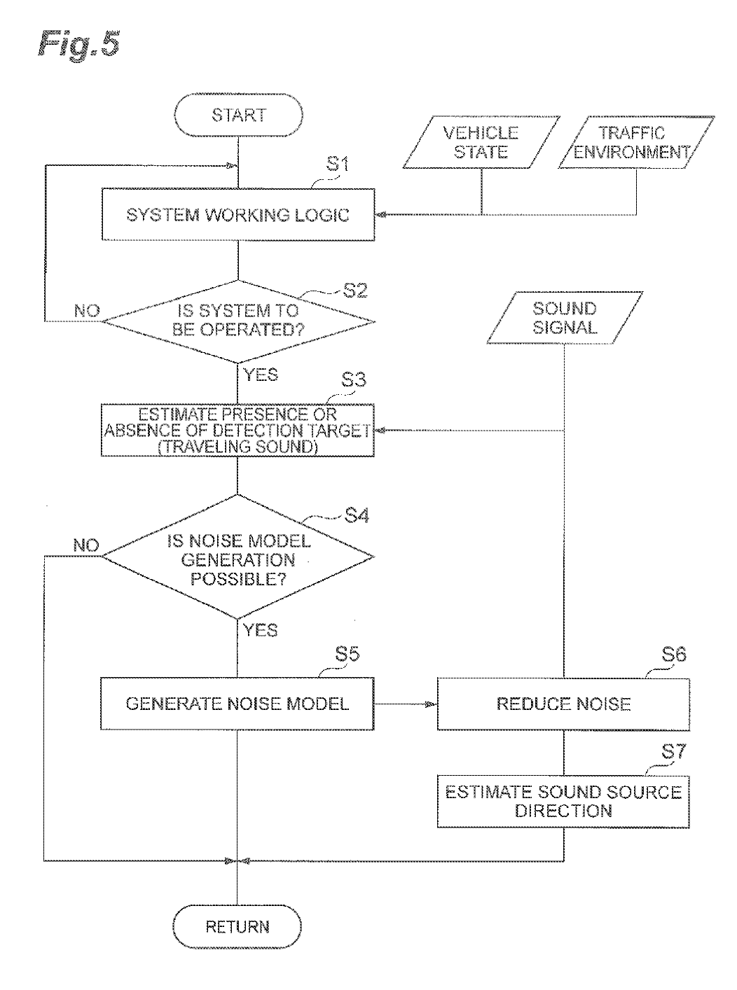

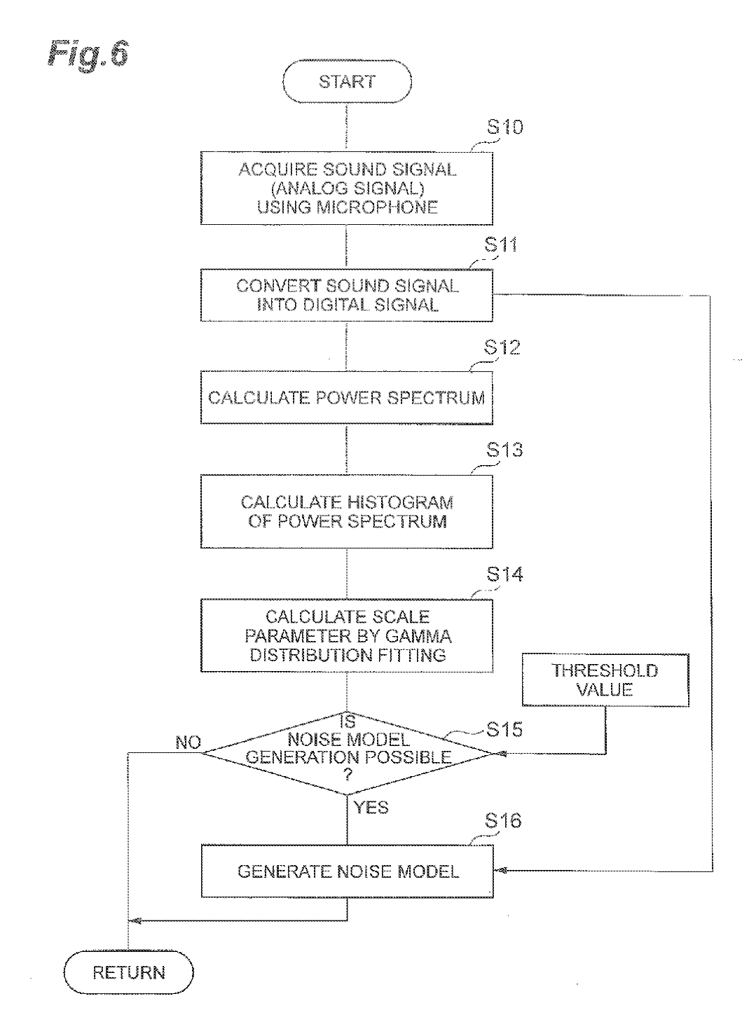

An operation of the approaching vehicle detection device 1A will be described. Here, an overall operation in the approaching vehicle detection device 1A will be described with reference to the flowchart of FIG. 5, and then, the operation relating to the noise model generation in the approaching vehicle detection device 1A will be described with reference to the flowchart of FIG. 6. FIG. 5 is a flowchart illustrating the flow of an overall operation in the approaching vehicle detection device according to the present embodiment. FIG. 6 is a flowchart illustrating the flow of an operation relating to noise model generation according to the first embodiment.

First, the overall operation in the approaching vehicle detection device 1A will be described. A system working logic of the approaching vehicle detection device 1A is determined based on a vehicle state or a traffic environment (S1), and it is determined whether the approaching vehicle detection device 1A is to be operated (S2). The system working logic is a condition for determining whether it is necessary to operate the approaching vehicle detection device 1A. For example, there is a condition that a vehicle speed is a predetermined speed or greater or lower, as the vehicle state, and a condition that an intersection point is present in front of the host vehicle, as the traffic environment. Thus, a higher device that generally manages the approaching vehicle detection device 1A is present, and this higher device (particularly, ECU) performs the respective processes S1 and S2. Then, if it is determined that the approaching vehicle detection device 1A is to be operated, the approaching vehicle detection device 1A is operated.

If it is determined in S2 that the approaching vehicle detection device 1A is to be operated, the approaching vehicle detection device 1A is operated. While the approaching vehicle detection device 1A is being operated, the following operations are repeated. In the approaching vehicle detection device 1A, the peripheral sound at the outside of the vehicle is collected by each of the microphones 11a, 11b, 12a, and 12b of the microphone array 10, the sound signal of each of the microphones 11a, 11b, 12a, and 12b is converted into the digital signal by the digital signal converter 20. The ECU 30A (noise model generator 31A) of the approaching vehicle detection device 1A estimates whether the traveling sound that is the detection target is present in the sound signal using the sound signal converted in the digital signal converter 20 (S3), and determines whether the noise model generation is possible from the estimation (S4). The ECU 30A of the approaching vehicle detection device 1A generates the noise model using the sound signal when it is determined in S4 that the noise model generation is possible (S5), and does not generate the noise model when it is determined in S4 that the noise model generation is not possible. The operations of S3 to S5 will be described later in detail.

Further, if the noise model generated in S5 is present, the ECU 30A (noise reducer 32) of the approaching vehicle detection device 1A reduces the noise component from the sound signal of each of the microphones converted by the digital signal converter 20 using the noise model (S6). On the other hand, if the noise model generated in S5 is not present, the noise component is reduced from the sound signal of each of the microphones converted by the digital signal converter 20 using a noise model that is prepared in advance (S6). Specifically, the case where the noise model is not present includes a case where the generation of the noise model is not executed even once, and a case where the generation of the noise model is not executed between a predetermined time before a current point in time and the current point in time, for example. Further, the ECU 30A (sound source direction estimator 33) determines whether the sound source of the detection target (traveling sound of the approaching vehicle to the host vehicle) is present using the sound signal of each of the microphones in which the noise component is reduced in S6, and estimates the direction, distance or the like of the sound source of the detection target if the sound source of the detection target is present (S7). Furthermore, the ECU 30A generates the approaching vehicle information based on the detection result of the sound source, and outputs the approaching vehicle information to the drive assist device 2. When the noise model is not yet generated in S6, the noise reduction is performed using the prepared noise model, but when the noise model is not yet generated, a configuration in which it is determined whether the sound source of the detection target is present in a state where the noise reduction is not performed may be used.

Next, the operation relating to the noise model generation in the approaching vehicle detection device 1A will be described. Each of the microphones 11a, 11b, 12a, and 12b of the microphone array 10 collects the peripheral sound at the outside of the vehicle to acquire the analog sound signal (S10). The digital signal converter 20 converts the analog sound signal of each of the microphones 11a, 11b, 12a, and 12b into the digital sound signal (S11).

The ECU 30A (power spectrum calculator 31a) performs FFT for the sound signal converted into the digital signal in S11, and calculates the power spectrum of the sound signal (S12). Then, the ECU 30A (histogram calculator 31b) calculates the histogram of the power spectrum in the frequency band where the traveling sound is predominant, from the power spectrum (S13). Then, the ECU 30A (scale parameter calculator 31c) performs gamma distribution fitting using data on the power spectrum in the frequency band where the traveling sound is predominant to calculate the scale parameter (S14).

Thereafter, the ECU 30A (noise model generation possibility determiner 31d) compares the scale parameter with the threshold value to determine whether the noise model generation is possible (S15). In S15, if the scale parameter is equal to or greater than the threshold value, it is determined that the noise model generation is not possible, and the noise model is not generated. In contrast, in S15, if the scale parameter is smaller than the threshold value, it is determined that the noise model generation is possible, and the ECU 30A (noise model generator 31e) generates the noise model using the sound signal converted into the digital signal in S11 (S16).

According to the approaching vehicle detection device 1A, it is possible to determine whether the traveling sound (sound source of the detection target) is included in the sound signal by evaluating the histogram of the power spectrum of the sound signal, with high accuracy, and thus, a timing suitable for the noise model generation can be determined, and the noise model can be adaptively generated for the respective environments. By using the noise model generated in this way, the reduction effect of the noise component from the sound signal is enhanced. By using the sound signal in which the noise component is reduced, the approaching vehicle can be detected with high accuracy. Further, according to the approaching vehicle detection device 1A, by using the scale parameter based on the gamma distribution fitting, the histogram of the power spectrum can be evaluated with high accuracy.

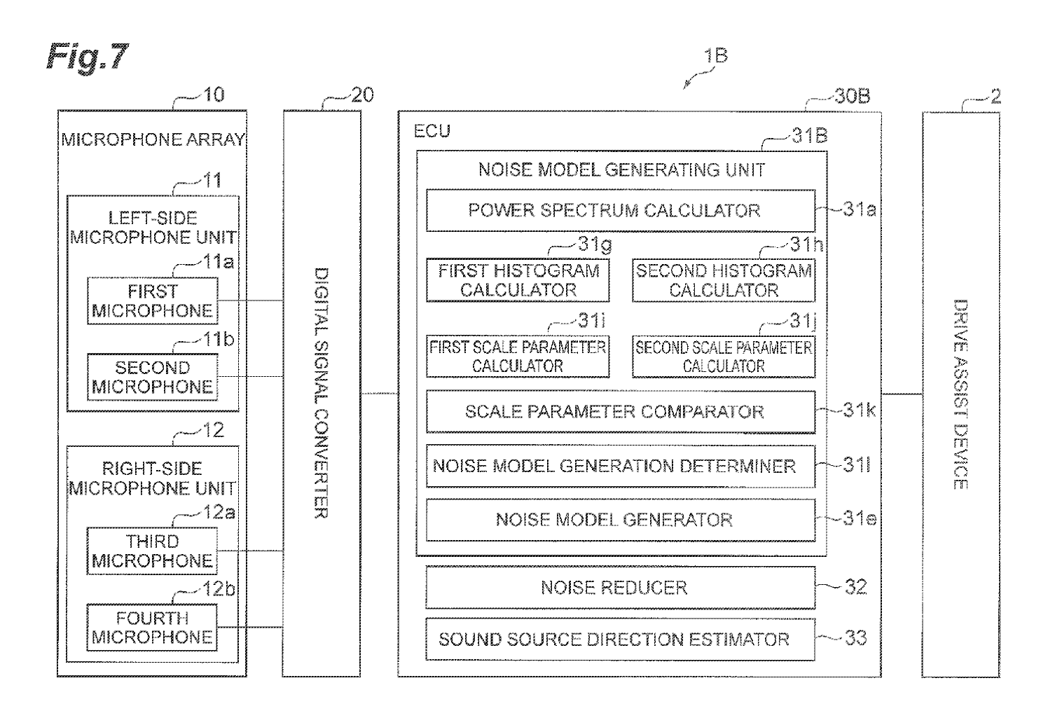

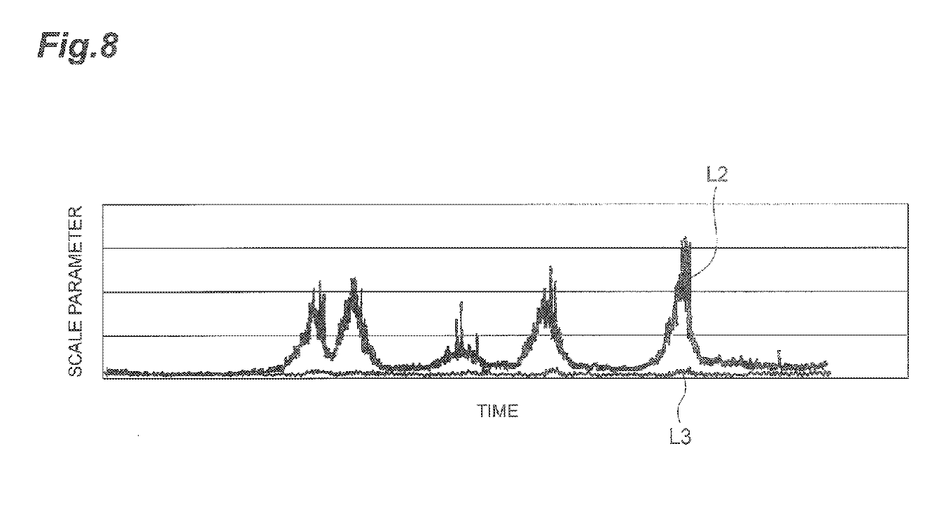

An approaching vehicle detection device 1B according to a second embodiment will be described with reference to FIGS. 7 and 8. FIG. 7 is a configuration diagram of an approaching vehicle detection device according to the second embodiment. FIG. 8 is a diagram illustrating an example of a temporal change of a scale parameter in a frequency band where traveling sound is observed and a scale parameter in a frequency band where traveling sound is not observed.

When comparing with the approaching vehicle detection device 1A according to the first embodiment, the approaching vehicle detection device 1B has a function of determining whether the traveling sound is included in the sound signal collected using the microphones from two frequency band characteristics in the collected sound signals. Thus, the approaching vehicle detection device 1B calculates a power spectrum of the sound signal, and evaluates a histogram of a power spectrum in a first frequency band where the traveling sound (sound source of the detection target) is included and a histogram of a power spectrum in a second frequency band where the traveling sound is not included, by gamma distribution fitting.

Before specifically describing the configuration of the approaching vehicle detection device 1B, with reference to FIG. 8, the relationship between a scale parameter of the first frequency band where the traveling sound is included and a scale parameter of the second frequency band where the traveling sound is not included will be described. Under the environment where the traveling sound is not present, because of the environment where the traveling sound includes a noise environment such as white noise or pink noise, there is continuity in power distribution in all frequency bands. In contrast, under the environment where the traveling sound is present, since the power distribution varies in the frequency band where the traveling sound is included, there is no continuity between the frequency band where the traveling sound is included and frequency bands other than the frequency band. Accordingly, by comparing the histograms of the power spectra in two frequency bands, it is possible to determine whether the environment is the environment where the traveling sound is not present (environment suitable for generation of the noise model) or the environment where the traveling sound is present (environment unsuitable for generation of the noise model) with high accuracy.

Thus, by comparing and evaluating the histogram of the power spectrum in the frequency band where the traveling sound is included with the histogram of the power spectrum of the frequency band where the traveling sound is not included, it is determined whether the environment is the environment where the traveling sound is not present or the environment where the traveling sound is present, to thereby detect a timing (section) that is the environment where the traveling sound is not present. In this evaluation, the scale parameter based on the gamma distribution fitting is used as a feature amount, as described in the first embodiment.

FIG. 8 shows an example of a temporal change of the scale parameter calculated from the power spectrum in the frequency band where the traveling sound is included in the sound signal collected while the vehicle is traveling by a solid line L2, and shows an example of a temporal change of the scale parameter calculated from the power spectrum in the frequency band where the traveling sound is not included in the same sound signal by a solid line L3. As understood from the solid line L2, in a time zone where the traveling sound is not observed, the scale parameter is close to 0, and in time zones where the traveling sound is observed, the scale parameter becomes noticeably large. On the other hand, as understood from the solid line L3, not only in the case of the frequency band where the traveling sound is not included, but also in a time zone where the traveling sound is not observed and in time zones where the traveling sound is observed, the scale parameter is close to 0. In this way, by comparing the scale parameter in the frequency band where the traveling sound is included with the scale parameter in the frequency band where the traveling sound is not included, it is possible to determine whether the environment is the environment where the traveling sound is present and the environment where the traveling sound is not present.

Thus, in the second embodiment, in order to compare and evaluate the histogram of the power spectrum in the first frequency band where the traveling sound is included with the histogram of the power spectrum of the second frequency band where the traveling sound is not included, a shape parameter of gamma distribution in the first frequency band and a shape parameter of gamma distribution in the second frequency band are calculated using gamma distribution fitting, a scale parameter of the gamma distribution in the first frequency band and a scale parameter of the gamma distribution in the second frequency band are calculated from the shape parameters, and two scale parameters (particularly, a difference between the two scale parameters, or a ratio thereof) is used as a feature amount of evaluation.

As the first frequency band (frequency band where the traveling sound is predominant), a band including a frequency band of the traveling sound of the vehicle that is measured in advance by an actual vehicle experiment or the like may be set. As the second frequency band (frequency band where the traveling sound is not predominant), a band other than the first frequency band in a frequency band capable of being detected using the microphones may be set. For example, as the second frequency band, a band from a maximum frequency of the first frequency band to a frequency that is smaller by a predetermined amount than an upper limit frequency capable of being detected using the microphones may be set.

Next, the configuration of the approaching vehicle detection device 1B will be described. The approaching vehicle detection device 1B includes the microphone array 10, the digital signal converter 20, and an ECU 30B (noise model generator 31B, noise reducer 32, and sound source direction estimator 33). Hereinafter, the ECU 30B (particularly, noise model generator 31B) will be described in detail.

The ECU 30B is an electronic control unit including a CPU, a ROM, a RAM and the like, and generally controls the approaching vehicle detection device 1B. The ECU 30B includes the noise model generator 31B (power spectrum calculator 31a, first histogram calculator 31g, second histogram calculator 31h, first scale parameter calculator 31i, second scale parameter calculator 31j, scale parameter comparator 31k, noise model generation possibility determiner 31l, and noise model generator 31e), the noise reducer 32, and the sound source direction estimator 33. The ECU 30B receives the sound signal (digital electric signal) for each microphone from the digital signal converter 20. Here, since the power spectrum calculator 31a, the noise model generator 31e, the noise reducer 32, and the sound source direction estimator 33 have been already described, the description will not be repeated.

In the second embodiment, the power spectrum calculator 31a corresponds to a power spectrum acquisition unit disclosed in claims, the first scale parameter calculator 31i and the second scale parameter calculator 31j correspond to a scale parameter calculation unit disclosed in claims, the scale parameter comparator 31k and the noise model generation possibility determiner 31l correspond to a determination unit disclosed in claims, the noise model generator 31e corresponds to a noise model generation unit disclosed in claims, and the noise reducer 32 corresponds to a noise reduction unit disclosed in claims.

The first histogram calculator 31g calculates a histogram of a power spectrum in the first frequency band where the traveling sound is predominant from the power spectrum calculated by the power spectrum calculator 31a. Further, the second histogram calculator 31h calculates a histogram of a power spectrum in the second frequency band where the traveling sound is not predominant from the power spectrum calculated by the power spectrum calculator 31a.

The first scale parameter calculator 31i performs gamma distribution fitting using data on the power spectrum in the first frequency band where the traveling sound is predominant to calculate a scale parameter of the first frequency band where the traveling sound is predominant. Further, the second scale parameter calculator 31j performs gamma distribution fitting using data on the power spectrum in the second frequency band where the traveling sound is not predominant to calculate a scale parameter of the second frequency band where the traveling sound is not predominant.

The scale parameter comparator 31k subtracts the scale parameter of the second frequency band calculated by the second scale parameter calculator 31j from the scale parameter of the first frequency band calculated by the first scale parameter calculator 31i to calculate a difference between the two scale parameters.

The noise model generation possibility determiner 31l compares the difference between the scale parameters calculated by the scale parameter comparator 31k with a threshold value. If the difference between the scale parameters is equal to or greater than the threshold value (when the scale parameter of the first frequency band becomes larger, an obvious difference occurs between the scale parameters of the two frequency bands, and thus, it can be determined that the traveling sound is included in the sound signal), the noise model generation possibility determiner 31l determines that the noise model generation is not possible, and if the scale parameter is lower than the threshold value (when an obvious difference does not occur between the scale parameters of the two frequency bands, and thus, it can be determined that the traveling sound is not included in the sound signal), the noise model generation possibility determiner 31l determines that the noise model generation is possible. The threshold value refers to a threshold value for determining whether the traveling sound is included in the sound signal based on the difference or ratio between the scale parameters of the two frequency bands, which is set in advance by an actual experiment or the like.

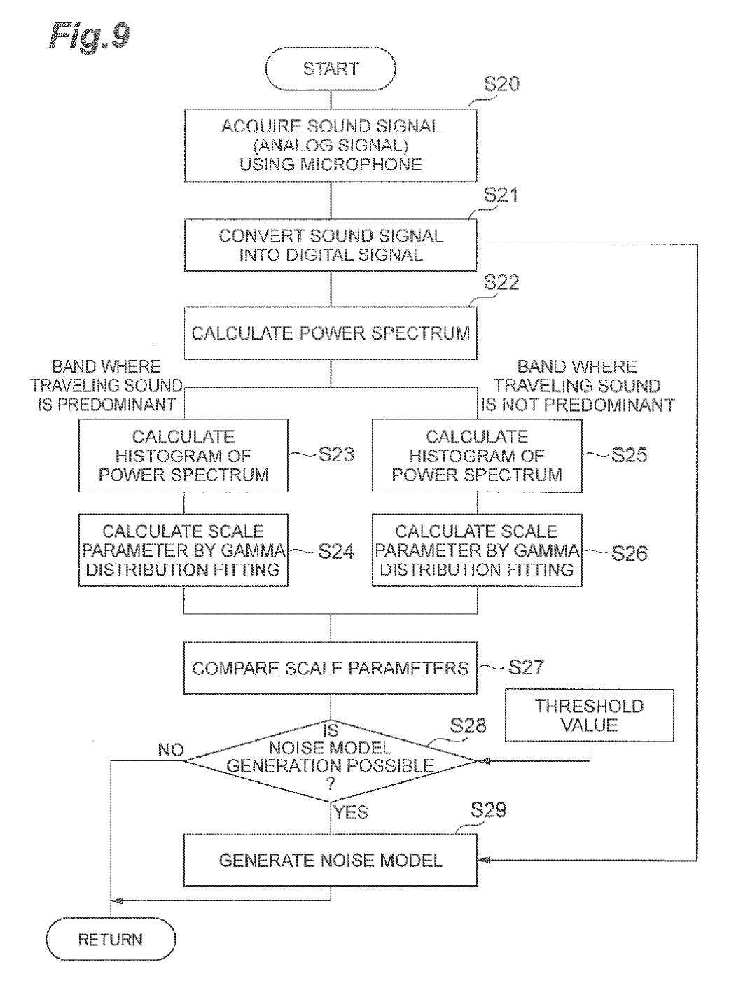

An operation of the approaching vehicle detection device 1B will be described. Here, an operation relating to noise model generation in the approaching vehicle detection device 1B will be described with reference to the flowchart of FIG. 9. FIG. 9 is a flowchart illustrating the flow of an operation relating to noise model generation according to the second embodiment. Since operations other than the operation relating to the noise model generation in the approaching vehicle detection device 1B are the same as in the approaching vehicle detection device 1A according to the first embodiment, the description will not be repeated.

Since operations in S20, S21, and S22 in the approaching vehicle detection device 1B are the same as in S10, S11, and S12 in the approaching vehicle detection device 1A according to the first embodiment, the description will not be repeated.

If the power spectrum of the sound signal is calculated, the ECU 30B (first histogram calculator 31g) calculates the histogram of the power spectrum in the first frequency band where the traveling sound is predominant from the power spectrum (S23). Then, the ECU 30B (first scale parameter calculator 31i) performs the gamma distribution fitting using the data on the power spectrum in the first frequency band where the traveling sound is predominant to calculate the scale parameter of the first frequency band (S24). Then, the ECU 30B (second histogram calculator 31h) calculates the histogram of the power spectrum in the second frequency band where the traveling sound is not predominant from the power spectrum (S25). Then, the ECU 30B (second scale parameter calculator 31j) performs the gamma distribution fitting using the data on the power spectrum in the second frequency band where the traveling sound is not predominant to calculate the scale parameter of the second frequency band (S26).

Thereafter, the ECU 30B (scale parameter comparator 31k) calculates the difference between the scale parameter of the first frequency band calculated in S24 and the scale parameter of the second frequency band calculated in S26 (S27). Then, the ECU 30B (noise model generation possibility determiner 31l) compares the difference between the scale parameters with the threshold value to determine whether the noise model generation is possible (S28). In S28, if the difference between the scale parameters is equal to or greater than the threshold value, it is determined that the noise model generation is not possible, and the noise model is not generated. In contrast, in S28, if the difference between the scale parameters is lower than the threshold value, it is determined that the noise model generation is possible. The ECU 30B (noise model generator 31e) generates the noise model using the sound signal converted into the digital signal in S21 (S29).

The approaching vehicle detection device 1B has the following effects, in addition to the same effects as in the approaching vehicle detection device 1A according to the first embodiment. According to the approaching vehicle detection device 1B, it is possible to determine whether the traveling sound is included in the sound information with high accuracy by comparing and evaluating the histogram of the power spectrum in the first frequency band where the traveling sound is included with the histogram of the power spectrum in the second frequency band where the traveling sound is not included, and thus, a timing suitable for the noise model generation can be determined, and the noise model can be generated adapted to an environmental change.

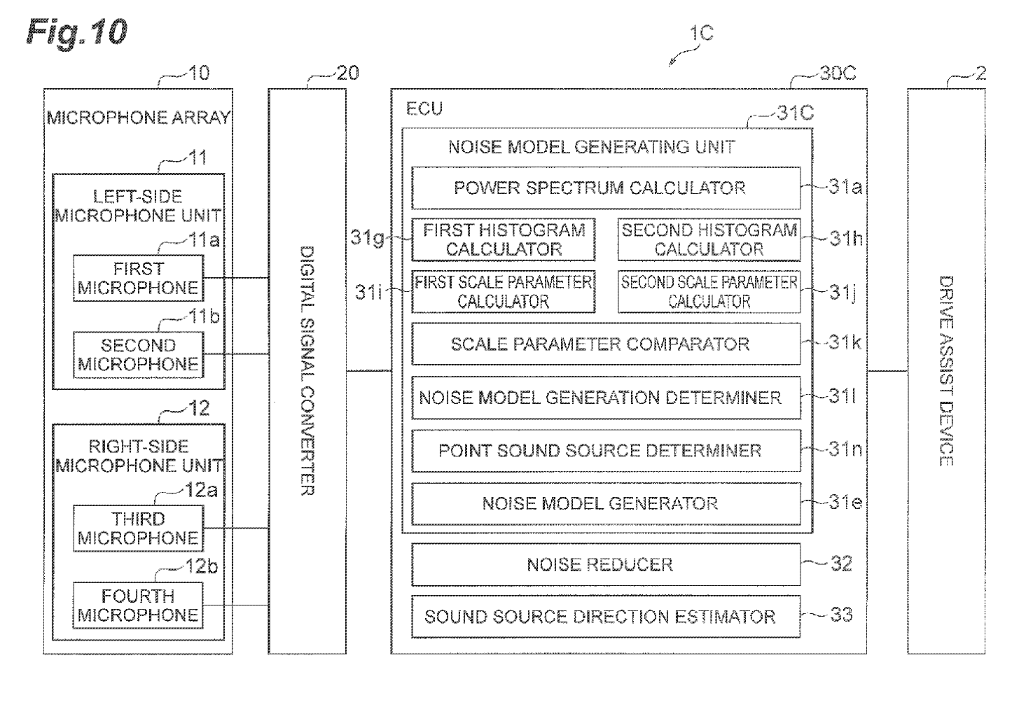

An approaching vehicle detection device 1C according to a third embodiment will be described with reference to FIG. 10. FIG. 10 is a configuration diagram of an approaching vehicle detection device according to the third embodiment.

When comparing with the approaching vehicle detection device 1B according to the second embodiment, the approaching vehicle detection device 1C has a function that does not generate the noise model when a point sound source is present even when the difference between the scale parameters in the first frequency band and the second frequency band is small (even when it is determined that the noise model generation is possible).

Before specifically describing the configuration of the approaching vehicle detection device 1C, the point sound source will be described. The point sound source refers to a specific sound source which is not an environmental noise such as white noise or pink noise. In the sound source direction estimator 33, the sound source of the detection target is the traveling sound of the vehicle (one of point sound sources), and thus, there is a high probability that the sound source detected by the sound source direction estimator 33 is the traveling sound of the vehicle.

In this regard, the sound source of the detection target is detected in the sound source direction estimator 33, but there is a case where the difference between the scale parameters in the first frequency band and the second frequency band is still small (when the sound source of the detection target is present distant from the host vehicle, for example). In such a case, it may be determined that the noise model generation is possible in the determination of the difference between the scale parameters according to setting of the threshold value, and thus, there is a possibility that the traveling sound component is included in the sound signal.

Thus, in the third embodiment, it is determined whether the point sound source is present in the sound signal using the detection result of the sound source of the detection target of the sound source direction estimator 33, and if the point sound source is present, the noise model generation is not performed.

Next, the configuration of the approaching vehicle detection device 1C will be described. The approaching vehicle detection device 1C includes the microphone array 10, the digital signal converter 20, and an ECU 30C (noise model generation unit 31C, noise reducer 32, and sound source direction estimator 33). Hereinafter, the ECU 30 (particularly, noise model generation unit 31C) will be described in detail.

The ECU 30C is an electronic control unit including a CPU, a ROM, a RAM and the like, and generally controls the approaching vehicle detection device 1C. The ECU 30C includes the noise model generation unit 31C (power spectrum calculator 31a, first histogram calculator 31g, second histogram calculator 31h, first scale parameter calculator 31i, second scale parameter calculator 31j, scale parameter comparator 31k, noise model generation possibility determiner 31l, point sound source determiner 31n, and noise model generator 31e), the noise reducer 32, and the sound source direction estimator 33. The ECU 30C receives the sound signal (digital electric signal) for each microphone from the digital signal converter 20. Here, since the power spectrum calculator 31a, the first histogram calculator 31g, the second histogram calculator 31h, the first scale parameter calculator 31l, the second scale parameter calculator 31j, the scale parameter comparator 31k, the noise model generation possibility determiner 31l, the noise model generator 31e, the noise reducer 32, and the sound source direction estimator 33 have been already described, the description will not be repeated.

In the third embodiment, the power spectrum calculator 31a corresponds to a power spectrum acquisition unit disclosed in claims, the first scale parameter calculator 31i and the second scale parameter calculator 31j correspond to a scale parameter calculation unit disclosed in claims, the scale parameter comparator 31k and the noise model generation possibility determiner 31l correspond to a determination unit disclosed in claims, the sound source direction estimator 33 and the point sound source determiner 31n correspond to a point sound source detection unit disclosed in claims, the noise model generator 31e corresponds to a noise model generation unit disclosed in claims, and the noise reducer 32 corresponds to a noise reduction unit disclosed in claims.

If it is determined by the noise model generation possibility determiner 31l that noise model generation is possible, the point sound source determiner 31n determines whether a detection target sound source (that is, point sound source) is present based on the detection result of the detection target sound source in the sound source direction estimator 33.

When it is determined by the point sound source determiner 31n that the point sound source is present even when it is determined by the noise model generation possibility determiner 31l that the noise model generation is possible, the noise model generator 31e does not generate the noise model.

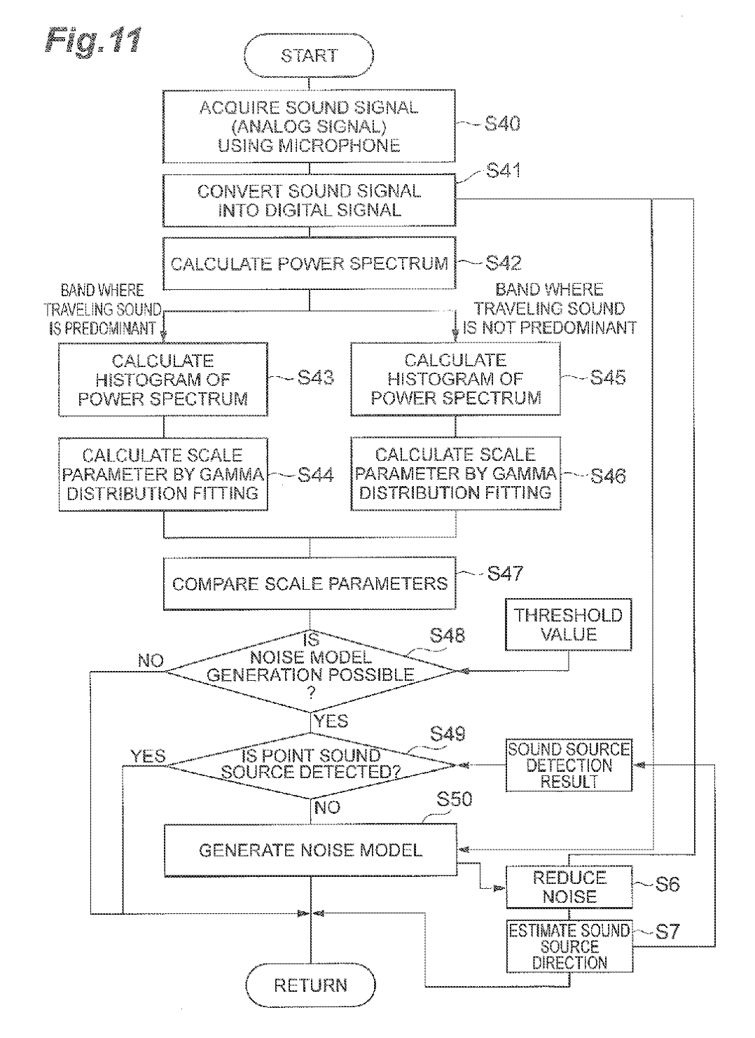

An operation of the approaching vehicle detection device 1C will be described. Here, an operation relating to noise model generation in the approaching vehicle detection device 1C will be described with reference to the flowchart of FIG. 11. FIG. 11 is a flowchart illustrating the flow of the operation relating to the noise model generation according to a third embodiment. Since operations other than the operation relating to the noise model generation in the approaching vehicle detection device 1C are the same as in the approaching vehicle detection device 1A according to the first embodiment, the description will not be repeated.

Since operations in S40 to S48 in the approaching vehicle detection device 1C are the same as in S20 to S28 in the approaching vehicle detection device 1B according to the second embodiment, the description will not be repeated.

If the ECU 30C (noise reducer 32) of the approaching vehicle detection device 1C reduces a noise component from the sound signal of each microphone converted into the digital signal in S41, using a noise model generated in S50 (using the noise model that is prepared in advance when the noise model is not generated) (S6). Further, the ECU 30C (sound source direction estimator 33) determines whether the sound source of the detection target (traveling sound of the approaching vehicle to the host vehicle) is present using the sound signal of each of the microphones in which the noise component is reduced in S6, and estimates the direction, distance or the like of the sound source of the detection target if the sound source of the detection target is present (S7).

If it is determined in S48 that the noise model generation is possible, the ECU 30C (point sound source determiner 31n) determines whether the point sound source is detected based on the detection result of the sound source of the detection target in S7 (S49). If it is determined in S49 that the point sound source is detected, the noise model is not generated. In contrast, if it is determined in S49 that the point sound source is not detected, the ECU 30C (noise model generator 31e) generates the noise model using the sound signal converted into the digital signal in S41 (S50).

The approaching vehicle detection device 1C has the following effects, in addition to the same effects as in the approaching vehicle detection device 1B according to the second embodiment. According to the approaching vehicle detection device 1C, even when it is determined that the difference between the scale parameters in the first frequency band and the second frequency band is small and the noise model generation is possible, by determining whether to perform the noise model generation in consideration of the presence or absence of the point sound source, it is possible to determine a timing suitable for generation of the noise model with high accuracy.

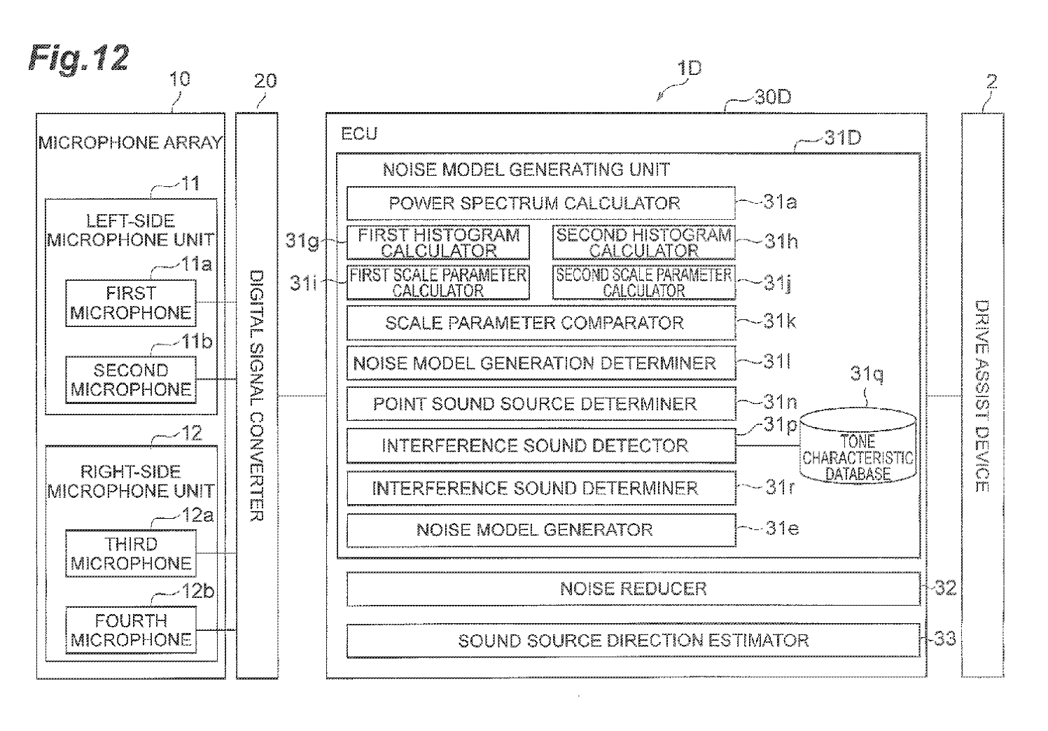

An approaching vehicle detection device 1D according to a fourth embodiment will be described with reference to FIG. 12. FIG. 12 is a configuration diagram of an approaching vehicle detection device according to the fourth embodiment.

When comparing with the approaching vehicle detection device 1C according to the third embodiment, the approaching vehicle detection device 1D has a function capable of generating a noise model when an interference sound (characteristic sound) other than the sound source of the detection target is present.

Before specifically describing the configuration of the approaching vehicle detection device 1D, the interference sound will be described. The interference sound refers to a characteristic sound other than the sound source of the detection target in a specific sound source (point sound source) which is not an environmental noise such as white noise or pink noise. In the sound source direction estimator 33, the sound source (traveling sound) of the detection target is detected, but a characteristic sound source having a frequency band overlapped with the traveling sound may be present under a certain environment. In this case, there is a possibility that the sound source detected by the sound source direction estimator 33 is an sound source other than the traveling sound. Such an sound source other than the traveling source corresponds to a noise component.

Thus, in the fourth embodiment, it is determined whether the interference sound is present in the sound signal by detecting the interference sound other than the sound source of the detection target, and if the interference sound is present, the noise model generation is performed.

Next, the configuration of the approaching vehicle detection device 1D will be described. The approaching vehicle detection device 1D includes the microphone array 10, the digital signal converter 20, and an ECU 30D (noise model generation unit 31D, noise reducer 32, and sound source direction estimator 33). Hereinafter, the ECU 30D (particularly, noise model generation unit 31D) will be described in detail.

The ECU 30D is an electronic control unit including a CPU, a ROM, a RAM and the like, and generally controls the approaching vehicle detection device 1D. The ECU 30D includes the noise model generation unit 31D (power spectrum calculator 31a, first histogram calculator 31g, second histogram calculator 31h, first scale parameter calculator 31i, second scale parameter calculator 31j, scale parameter comparator 31k, noise model generation possibility determiner 31l, point sound source determiner 31n, interference sound detector 31p, tone characteristic database 31q, interference sound determiner 31r, and noise model generator 31e), the noise reducer 32, and the sound source direction estimator 33. The ECU 30D receives the sound signal (digital electric signal) for each microphone from the digital signal converter 20. Here, since the power spectrum calculator 31a, the first histogram calculator 31g, the second histogram calculator 31h, the first scale parameter calculator 31i, the second scale parameter calculator 31j, the scale parameter comparator 31k, the noise model generation possibility determiner 31l, the point sound source determiner 31n, the noise model generator 31e, the noise reducer 32, and the sound source direction estimator 33 have been already described, the description will not be repeated.

In the fourth embodiment, the power spectrum calculator 31a corresponds to a power spectrum acquisition unit disclosed in claims, the first scale parameter calculator 31i and the second scale parameter calculator 31j correspond to a scale parameter calculation unit disclosed in claims, the scale parameter comparator 31k and the noise model generation possibility determiner 31l correspond to a determination unit disclosed in claims, the sound source direction estimator 33 and the point sound source determiner 31n correspond to a point sound source detector disclosed in claims, the interference sound detector 31p, the tone characteristic database 31q and the interference sound determiner 31r correspond to a characteristic sound detection unit disclosed in claims, the noise model generator 31e corresponds to a noise model generation unit disclosed in claims, and the noise reducer 32 corresponds to a noise reduction unit disclosed in claims.

The interference sound detector 31p detects the characteristic sound source (interference sound) other than the sound source of the detection target using the digital sound signal from the digital signal converter 20. As the detection method, for example, when the tone characteristic database 31q is provided, spectrum pattern recognition or the like is performed using respective sound sources and sound signals other than the sound source of the detection target stored in the tone characteristic database 31q to determine whether the sound source (interference sound) other than the sound source of the detection target is included in the sound signal. In the tone characteristic database 31q, spectrum patterns of the respective sound sources (for example, sound generated in each store, sound generated in a vending machine, engine sound of the vehicle, crossing alarm sound generated at a crossing, and noise due to an airplane or an electric train at an airport or around a station) other than the sound source (traveling sound) of the detection target that is present under an environment where the vehicle is traveling are stored. Further, when the tone characteristic database 31q is not provided, it is determined whether the sound signal has a harmonic wave structure (structure having periodicity in frequency) by linear predictive coding (LPC) or the like to detect the sound having the harmonic wave structure as the sound source (interference sound) other than the sound source of the detection target. The traveling sound of the vehicle does not have the harmonic wave structure due to the power distribution over the overall frequency bands.

When it is determined by the point sound determiner 31n that the point sound source is present, or when it is determined by the noise model generation possibility determiner 31l that the noise model generation is not possible, the interference sound determiner 31r determines whether the interference sound is present based on the detection result in the interference sound detector 31p.

Even if it is determined by the noise model generation possibility determiner 31l that the noise model generation is possible and it is determined by the point sound source determiner 31n that the point sound source is present, or even if it is determined by the noise model generation possibility determiner 31l that the noise model generation is not possible, when it is determined by the interference sound determiner 31r that the interference sound (sound source other than the sound source of the detection target) is present, the noise model generator 31e generates the noise model.

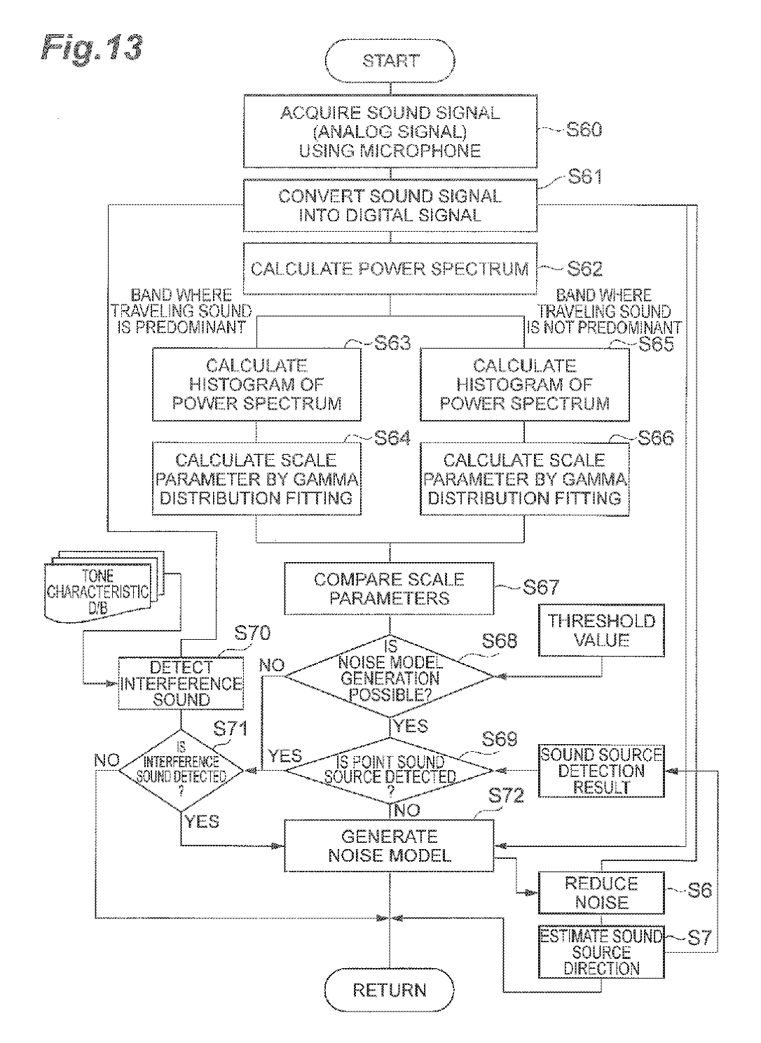

An operation of the approaching vehicle detection device 1D will be described. Here, an operation relating to noise model generation in the approaching vehicle detection device 1D will be described with reference to the flowchart of FIG. 13. FIG. 13 is a flowchart illustrating the flow of the operation relating to the noise model generation according to the fourth embodiment. Since operations other than the operation relating to the noise model generation in the approaching vehicle detection device 1D are the same as in the approaching vehicle detection device 1A according to the first embodiment, the description will not be repeated.

Since operations in S60 to S69, S6 and S7 in the approaching vehicle detection device 1D are the same as in S40 to S49, S6 and S7 in the approaching vehicle detection device 1C according to the third embodiment, the description will not be repeated.

The ECU 30D (interference sound detector 31p) of the approaching vehicle detection device 1D detects the interference sound other than the sound source of the target detection in the sound signal using the sound signal converted into the digital signal in S61 (S70). Here, when the tone characteristic database 31q is provided, the ECU 30D performs the spectrum pattern recognition or the like using the spectrum pattern of each sound source stored in the database 31q, and when the tone characteristic database 31q is not provided, the ECU 30D performs detection or the like of the sound having the harmonic wave structure.

If it is determined in S68 that the noise model generation is possible and it is determined in S69 that the point sound source is detected, or if it is determined in S68 that the noise model generation is not possible, the ECU 30D (interference sound determiner 31r) determines whether the interference sound is detected based on the detection result of the interference sound in S70 (S71). If it is determined in S71 that the interference sound is not detected, the noise model is not generated. In contrast, if it is determined in S71 that the interference sound is detected, the ECU 30C (noise model generator 31e) generates the noise model using the sound signal converted into the digital signal in S61 (S72).

The approaching vehicle detection device 1D has the following effects, in addition to the same effects as in the approaching vehicle detection device 1C according to the third embodiment. According to the approaching vehicle detection device 1D, even when it is determined that the point sound source is present, or even when it is determined that the difference between the scale parameters in the first frequency band and the second frequency band is large and the noise model generation is not possible, by determining the noise model generation in consideration of the presence or absence of the interference sound, it is possible to determine a timing suitable for generation of the noise model with high accuracy.

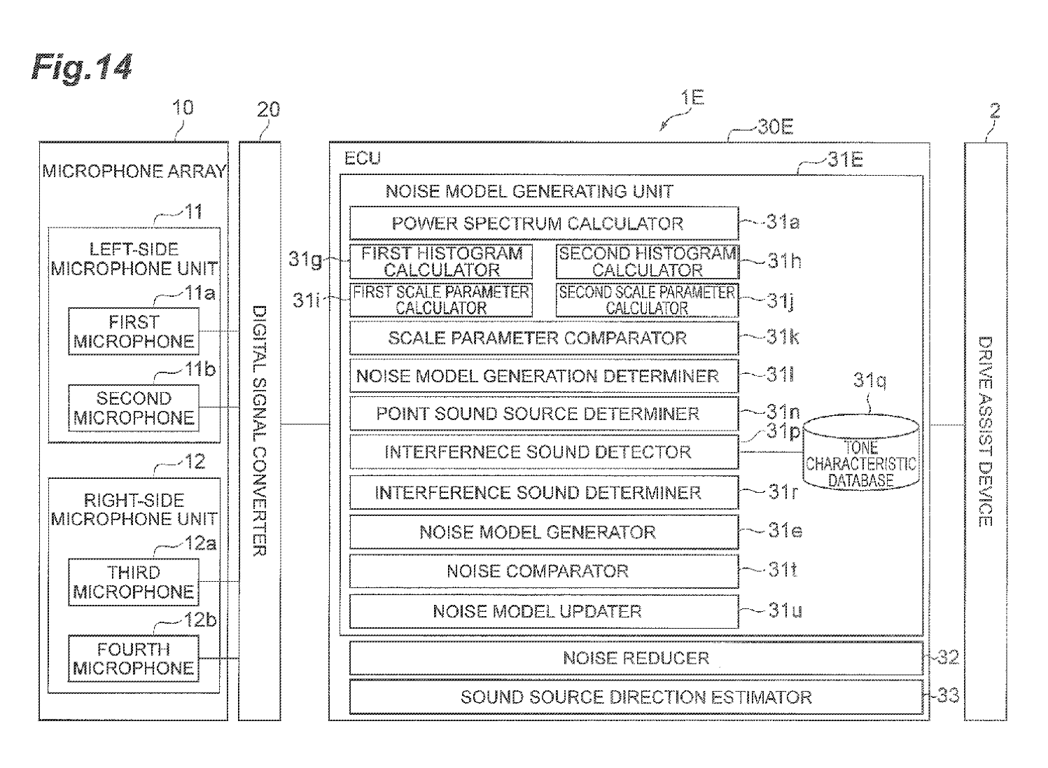

An approaching vehicle detection device 1E according to a fifth embodiment will be described with reference to FIG. 14. FIG. 14 is a configuration diagram of an approaching vehicle detection device according to the fifth embodiment.

When comparing with the approaching vehicle detection device 1D according to the fourth embodiment, the approaching vehicle detection device 1E has a function capable of changing a noise model according to an environmental change when the noise model is already generated.

Before specifically describing a configuration of the approaching vehicle detection device 1E, the necessity of updating the noise model will be described. If the surrounding environment is changed while the vehicle is traveling even after the noise model is generated, the noise component may be changed according to the environment. In order to cope with such an environmental change, if the noise model is re-generated from the sound signal acquired from each environment every time, the processing load increases. Every time the noise model is re-generated, for example, if the noise model is generated when a characteristic sound is instantly generated under a certain environment, a discontinuous noise model is obtained. Thus, if the noise reduction is performed in the next process using the noise model, the reduction effect is reduced.

Thus, in the fifth embodiment, when the noise model is already generated in the previous process, the generated noise model is compared with an sound signal (power spectrum) acquired under a current environment. If there is a change in the noise model, the noise model is updated in consideration of the sound signal (power spectrum) under the current environment.

Next, the configuration of the approaching vehicle detection device 1E will be described. The approaching vehicle detection device 1E includes the microphone array 10, the digital signal converter 20, and an ECU 30E (noise model generation unit 31E, noise reducer 32, and sound source direction estimator 33). Hereinafter, the ECU 30E (particularly, noise model generation unit 31E) will be described in detail.

The ECU 30E is an electronic control unit including a CPU, a ROM, a RAM and the like, and generally controls the approaching vehicle detection device 1E. The ECU 30E includes the noise model generation unit 31E (power spectrum calculator 31a, first histogram calculator 31g, second histogram calculator 31h, first scale parameter calculator 31i, second scale parameter calculator 31j, scale parameter comparator 31k, noise model generation possibility determiner 31l, point sound source determiner 31n, interference sound detector 31p, tone characteristic database 31q, interference sound determiner 31r, noise model generator 31e, noise comparator 31t, and noise model updater 31u), the noise reducer 32, and the sound source direction estimator 33. The ECU 30E receives the sound signal (digital electric signal) for each microphone from the digital signal converter 20. Here, since the power spectrum calculator 31a, the first histogram calculator 31g, the second histogram calculator 31h, the first scale parameter calculator 31i, the second scale parameter calculator 31j, the scale parameter comparator 31k, the noise model generation possibility determiner 31l, the point sound source determiner 31n, the interference sound detector 31p, the tone characteristic database 31q, the interference sound determiner 31r, the noise model generator 31e, the noise reducer 32, and the sound source direction estimator 33 have been already described, the description will not be repeated.

In the fifth embodiment, the power spectrum calculator 31a corresponds to a power spectrum acquisition unit disclosed in claims, the first scale parameter calculator 31i and the second scale parameter calculator 31j correspond to a scale parameter calculation unit disclosed in claims, the scale parameter comparator 31k and the noise model generation possibility determiner 31l correspond to a determination unit disclosed in claims, the sound source direction estimator 33 and the point sound source determiner 31n correspond to a point sound source detector disclosed in claims, the interference sound detector 31p, the tone characteristic database 31q and the interference sound determiner 31r correspond to a characteristic sound detection unit disclosed in claims, the noise model generator 31e corresponds to a noise model generation unit disclosed in claims, the noise model updater 31u corresponds to a noise model update unit disclosed in claims, and the noise reducer 32 corresponds to a noise reduction unit disclosed in claims.

When the noise model is already generated in the previous process, the noise comparator 31t compares the noise model with the sound signal (power spectrum) acquired under the current environment, and determines whether there is a change in the noise model.

If it is determined by the noise comparator 31t that there is the change, the noise model updater 31u updates the noise model in consideration of the sound signal (power spectrum) acquired under the current environment using a first infinite impulse response (IIR) filter. Specifically, an updated noise model N(ω)ₙ₊₁ is calculated by Expression (4) using a power spectrum A(ω) of the sound signal under the current environment and a noise model N(ω)ₙ before update. η in Expression (4) is a forgetting coefficient, which represents the degree of consideration of the power spectrum of the sound signal under the current environment. The forgetting coefficient is a value of 0 to 1, which may be a fixed value, or may be a variable value in consideration of the degree of change in the noise model or the like. The noise model may be updated using a method other than the method using the first IIR filter.

[Expression 2]

N(ω)ₙ₊₁=(1−η)N(ω)ₙ=+ηA(ω) (4)

When a condition that the noise model generation is not possible is obtained from the determination results of the noise model generation possibility determiner 31l, the point sound source determiner 31n, and the interference sound determiner 31r (when the sound source of the detection target is present), if the noise model is updated, the sound source component of the detection target is added to the noise model. Thus, in this case, the noise model update may not be performed.

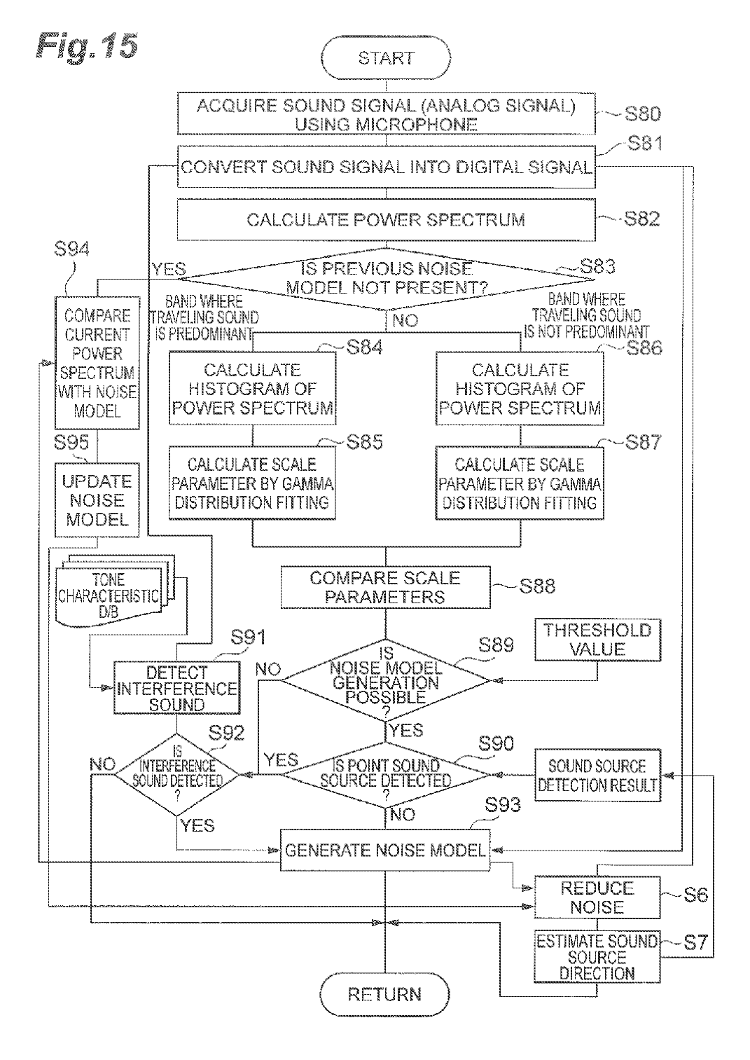

An operation of the approaching vehicle detection device 1E will be described. Here, an operation relating to noise model generation in the approaching vehicle detection device 1E will be described with reference to the flowchart of FIG. 15. FIG. 15 is a flowchart illustrating the flow of the operation relating to the noise model generation according to the fifth embodiment. Since operations other than the operation relating to the noise model generation in the approaching vehicle detection device 1E are the same as in the approaching vehicle detection device 1A according to the first embodiment, the description will not be repeated.

Since operations in S80 to S82, S84 to S93, S6, and S7 in the approaching vehicle detection device 1E are the same as in S60 to S62, S63 to S72, S6, and S7 in the approaching vehicle detection device 1D according to the fourth embodiment, the description will not be repeated.

If the power spectrum is calculated in S82, the ECU 30C determines whether a noise model generated in the previous process is not present (S83). If it is determined in S83 that no noise model generated in the previous process is present, a process of S84 and thereafter will be performed.

If it is determined in S83 that the noise model generated in the previous process is present, the ECU 30E (noise comparator 31t) compares the power spectrum of the current sound signal with the noise model, and determines whether there is a change in the noise model (S94). If there is the change in the noise model, the ECU 30E (noise model updater 31u) updates the noise model in consideration of the power spectrum of the current sound signal using the first IIR filter (S95).

The approaching vehicle detection device 1E has the following effects, in addition to the same effects as in the approaching vehicle detection device 1D according to the fourth embodiment. According to the approaching vehicle detection device 1E, when the noise model is generated, by updating the noise model in consideration of the sound signal collected under the current environment, it is possible to generate a suitable noise model adapted to the environmental change with a small processing load.

Hereinbefore, the embodiments according to the invention have been described, but the invention is not limited to the embodiments, and various modifications may be executed.

For example, the present embodiments are applied to a configuration in which the sound source direction estimation device is mounted on the vehicle and the approaching vehicle detection device detects the approaching vehicle (traveling sound of the vehicle as the sound source), but may be applied to a device that detects an sound source other than the vehicle, or may be applied to an sound source direction estimation device mounted on a moving body other than the vehicle. Further, the present embodiments are applied to a device that provides the detected approaching vehicle information to the drive assist device is used, but may be applied to another configuration. For example, the present embodiments may be applied to a configuration in which an approaching vehicle detection function is provided in the drive assist device, or a configuration in which an alarm function or the like is provided in the approaching vehicle detection device. In addition, the present embodiments may be applied to a noise model generation device that performs noise model generation from the sound information collected by the microphones. Furthermore, the present embodiments may be applied to a noise reduction device that performs noise model generation and performs noise reduction from the sound information collected by the microphones using the noise model.

Further, the present embodiments are applied to a configuration in which the histogram of the power spectrum of the sound is calculated, the scale parameter is calculated by the gamma distribution fitting, it is determined whether the noise model generation is possible based on the scale parameter, and the noise model is generated when the noise model generation is possible, but may be applied to an sound detection device (for example, approaching vehicle detection device) that detects the sound source of the detection target (traveling sound of the approaching vehicle) based on the scale parameter. The timing (section) when the noise model generation is not possible described in the present embodiments corresponds to a timing when the traveling sound (indicating that the approaching vehicle is present) can be detected.

In addition, in the present embodiments, an example in which four microphones are provided and the microphone array that includes the right and left microphone units is provided is shown, but various variations may be used for the number, arrangement or the like of the microphones (sound collectors). That is, even one microphone may be used.

Furthermore, in the present embodiments, a configuration in which the histogram of the power spectrum is calculated and the scale parameter is calculated by the gamma distribution fitting is used, but since the gamma distribution fitting is used, a configuration in which the scale parameter is calculated by the gamma distribution fitting directly using the power spectrum without calculating the histogram (configuration in which the histogram calculator is not provided) may be used.

Further, in the present embodiments, a configuration in which the gamma distribution is used for evaluation of the histogram of the power spectrum is used, but the histogram of the power spectrum may be evaluated by another evaluation method. For example, a normal distribution, a Laplace distribution, or a binomial distribution may be used. In addition, in the present embodiments, a configuration in which the scale parameter of the gamma distribution is used to determine whether the noise model can be generated is used, but another feature amount may be used to determine whether the noise model can be generated.

In addition, in the present embodiments, five embodiments are shown, and a configuration in which the function is added one by one as the number of each embodiment increases is used, but a combination of the added functions may be appropriately modified. For example, a configuration in which the noise model update function of the fifth embodiment is added to the first embodiment or a configuration in which the noise model update function of the fifth embodiment is added to the second embodiment may be used.

### INDUSTRIAL APPLICABILITY

The invention may be used for an sound source detection device that detects an sound source of a detection target from sound information collected by an sound collector, a noise model generation device that generates a noise model relating to noise information other than the sound source of the detection target included in the sound information collected by the sound collector, and a noise reduction device, an sound source direction estimation device, an approaching vehicle detection device, and a noise reduction method that use the noise model.

### REFERENCE SIGNS LIST

1A, 1B, 1C, 1D, 1E Approaching vehicle detection device
2 Drive assist device
10 Microphone array
11 Left-side microphone unit
11a First microphone
11b Second microphone
12 Right-side microphone
12a Third microphone
12b Fourth microphone
20 Digital signal converter
30A, 30B, 30C, 30D, 30E ECU
31A, 31B, 31C, 31D, 31E Noise model generation unit
31a power spectrum calculator
31b Histogram calculator
31c Scale parameter calculator
31d, 31l Noise model generation determiner
31e Noise model generator
31g First histogram calculator
31h Second histogram calculator
31i First scale parameter calculator
31j Second scale parameter calculator
31k Scale parameter comparator
31n Point sound source determiner
31p Interference sound detector
31q Tone characteristic database
31r Interference sound determiner
31t Noise comparator
31u Noise model updater
32 Noise reducer
33 Sound source direction estimator

1. An sound source detection device that detects an sound source of a detection target from sound information collected by an sound collector, comprising:
a power spectrum acquisition unit that acquires a power spectrum from the sound information collected by the sound collector,
a determination unit that determines whether the sound source of the detection target is included in the sound information collected by the sound collector, by evaluating a probability density distribution of the power spectrum acquired by the power spectrum acquisition unit; and
a scale parameter calculation unit that calculates a scale parameter of gamma distribution by gamma distribution fitting based on the power spectrum,
wherein the determination unit determines whether the sound source of the detection target is included in the sound information collected by the sound collector, by evaluating a probability density distribution of a power spectrum in a first frequency band set based on the sound source of the detection target and a probability density distribution of a power spectrum in a second frequency band other than the first frequency band, and evaluates the probability density distribution of the power spectrum using the scale parameter calculated by the scale parameter calculation unit.

2. (canceled)

3. (canceled)

4. A noise model generation device that generates a noise model relating to noise information other than an sound source of a detection target included in sound information collected by an sound collector, comprising:
a power spectrum acquisition unit that acquires a power spectrum from the sound information collected by the sound collector,
a determination unit that determines whether the sound source of the detection target is included in the sound information collected by the sound collector, by evaluating a probability density distribution of the power spectrum acquired by the power spectrum acquisition unit;
a noise model generation unit that generates a noise model from the sound information collected by the sound collector when it is determined by the determination unit that the sound source of the detection target is not included in the sound information; and
a scale parameter calculation unit that calculates a scale parameter of gamma distribution by gamma distribution fitting based on the power spectrum,
wherein the determination unit determines whether the sound source of the detection target is included in the sound information collected by the sound collector, by evaluating a probability density distribution of a power spectrum in a first frequency band set based on the sound source of the detection target and a probability density distribution of a power spectrum in a second frequency band other than the first frequency band, and evaluates the probability density distribution of the power spectrum using the scale parameter calculated by the scale parameter calculation unit.

5. (canceled)

6. (canceled)

7. The noise model generation device according to claim 4, further comprising:
a point sound source detection unit that detects a point sound source from the sound information collected by the sound collector,
wherein even if it is determined by the determination unit that the sound source of the detection target is not included in the sound information, when the point sound source is detected by the point sound source detection unit, the noise model generation unit does not generate the noise model.

8. The noise model generation device according to claim 4, further comprising:
a characteristic sound detection unit that detects a characteristic sound other than the sound source of the detection target from the sound information collected by the sound collector,
wherein when the characteristic sound other than the sound source of the detection target is detected by the characteristic sound detection unit, the noise model generation unit generates the noise model.

9. The noise model generation device according to claim 4, further comprising:
a noise model update unit that updates, when the noise model is already generated by the noise model generation unit, the noise model using the sound information collected by the sound collector.

10. A noise reduction device that reduces noise other than an sound source of a detection target included in sound information collected by an sound collector, comprising:
the noise model generation device according to claim 4,
wherein the noise other than the sound source of the detection target is reduced from the sound information collected by the sound collector using the noise model generated by the noise model generation device.

11. An sound source direction estimation device that estimates the direction of an sound source of a detection target included in sound information collected by an sound collector, comprising:
the noise reduction device according to claim 10,
wherein the direction of the sound source of the detection target is estimated from the sound information from which the noise is reduced by the noise reduction device.

12. An approaching vehicle detection device that detects an approaching vehicle based on sound information collected by an sound collector mounted on a vehicle, comprising:
the sound source direction estimation device according to claim 11,
wherein the sound source direction estimation device estimates the direction of an sound source generated from the approaching vehicle.

13. A noise reduction device that reduces noise other than an sound source of a detection target included in sound information collected by an sound collector, comprising:
a determination unit that determines whether the sound source of the detection target is included in the sound information collected by the sound collector;
a noise model generation unit that generates a noise model from the sound information collected by the sound collector if it is determined by the determination unit that the sound source of the detection target is not included in the sound information; and
a noise reduction unit that reduces the noise other than the sound source of the detection target from the sound information collected by the sound collector using the noise model generated by the noise model generation unit.

14. The noise reduction device according to claim 13,
wherein the noise reduction unit reduces the noise other than the sound source of the detection target from the sound information collected by the sound collector using the noise model generated by the noise model generation unit if the noise model generated by the noise model generation unit is present, and reduces the noise other than the sound source of the detection target from the sound information collected by the sound collector using a noise model that is prepared in advance or does not reduce the noise if the noise model generated by the noise model generation unit is not present.

15. A noise reduction method for reducing noise other than an sound source of a detection target included in sound information collected by an sound collector, comprising:
a determination step of determining whether the sound source of the detection target is included in the sound information collected by the sound collector;
a noise model generation step of generating a noise model from the sound information collected by the sound collector if it is determined that the sound source of the detection target is not included in the sound information in the determination step; and
a noise reduction step of reducing the noise other than the sound source of the detection target from the sound information collected by the sound collector using the noise model generated in the noise model generation step.
